(19) United States
(12) Patent Application Publication
(10) Pub. No.: US 2011/0225007 A1
(43) Pub. Date: Sep. 15, 2011

(54) Method and Apparatus of Providing and Maintaining Personal Health Care Records

(76) Inventor: Gerald A. Theis, Greendale, WI (US)

(21) Appl. No.: 13/129,667

(22) PCT Filed: Nov. 17, 2009
(86) PCT No.: PCT/US09/06139

§ 371 Date: May 17, 2011

Related U.S. Application Data
(60) Provisional application No. 61/199,383, filed on Nov. 17, 2008.

(51) Int. Cl. G06Q 50/00; A63B 69/00

(52) U.S. Cl. 705/2; 434/247

(57) ABSTRACT

In accordance with the present invention there is provided a method for distribution of medical information and patient services including providing coaches to effectuate behavioral changes in patients including addressing health, wellness, mental health, and productivity issues, wherein said coaches have undertaken coach training and use substantially the same coaching skills and methodology, and wherein the coaches are as a group heterogeneous in that some of said coaches possess credentials in nutrition and weight management, and some of said coaches possess credentials in mental health.

### CROSS-REFERENCE TO RELATED APPLICATIONS

This application claims priority of U.S. provisional patent application No. 61/199,383 filed on Nov. 17, 2008.

### BACKGROUND OF THE INVENTION

From the mid to late 1990s, a number of Internet companies have emerged to provide health information to consumers in the form of health regimens, disease-specific content or “health journals.” In the course of this growing trend toward self-help tools and consumer activism, a number of internet firms introduced online health information forms where consumers could record their health conditions, medications and medical history. These forms evolved as did the firms from a basic intake sheet (similar to the forms a patient completes on their first visit to a doctor's office) to elaborate, all inclusive, in-depth health status questionnaires that are either disease specific or used for monitoring health condition(s).

Everyone is talking about personal health records (PHRs). The worldwide market for the Electronic Medical Record and PHR is expected to be significant The PHR is still viewed as an emerging product. Recently, the Center for Information Technology Leadership estimated that approximately $20 B could be saved each year in the US through the use of PHRs and more than 70% of consumers support electronic healthcare data sharing. Connectivity with healthcare organizations will be required to make PHR's easy to access and manage. Increasingly, companies that want to manage healthcare costs and increase employee satisfaction are looking at PHRs as a cornerstone of their health management strategy.

Companies using them to help employees take control of their health status and become more knowledgeable and involved healthcare consumers.

The PHR, unlike the Electronic Medical Record, thus far has no established set of criteria or standards of definition for what features, functions or capabilities constitute a full-fledged PHR. With the wide range of approaches introduced by different PHR firms, there have been recent efforts for a consensus of certification standards and criteria.

The current definitions are as follows:
“The Personal Health Record (PHR) is an Internet-based set of tools that allows consumers to access and utilize their vital medical health information and make it readily available to those who need it.”
“The PHR is an integrated and comprehensive view of health information, including data that the consumers maintain, update and report themselves such as medical conditions, prescriptions, advance directives, diagnostic test results, and information from their pharmacies and insurance companies.”

The use of PHR technology holds the key for enabling individuals to maintain a copy of their health information, share that information with family members however, whenever, and wherever they wish, and electronically transmit to health care providers.

The Certification Commission for Healthcare Information Technology (CCHIT®):

The is an officially “recognized certification body” in the US for health information technology—a private, nonprofit organization that is to electronic health information products what Underwriters Laboratories is to electrical products. The Commission applies standards, tests products, and awards a “seal of compliance” to health information products.

CCHIT, created in 2005, to develop Standards and Certification needed to identify and harmonize technical standards related to health information exchange. To accomplish this, there is a need to oversee the development and presentation of use cases, to coordinate work with the Health IT Standards Panel (HITSP) and the Nationwide Health Information Network (NHIN) effort, and to support the certification efforts of the Certification Commission for Healthcare Information Technology (CCHIT) in its certification and accreditation activities. For example, CCHIT certifies provider-based ambulatory care electronic health records (EHRs) and inpatient EHRs through a public-private process that develops specific criteria for health IT systems and then rigorously evaluates them to determine that they truly meet the criteria for:
Functionality—ensuring that the systems can support the activities and perform the functions for which they are intended;
Security—ensuring that systems can protect and maintain the confidentiality of data entrusted to them; and
Interoperability—ensuring that systems implement the recognized standards and can exchange information and work with other systems

As part of the development of criteria for personal health records (PHR), the CCHIT Work Group has spent a great deal of time discussing privacy and how the PHR vendor manages it.

Examples of areas CCHIT Certified PHR products to meet:
Consent. Consumers should be in control of their personal health information and how it is used. PHRs that meet certification requirements must include safeguards that require consumers to give explicit written consent before anyone has access. Consumers should also be able to decide if the data can be collected, displayed, accessed, stored, released or disclosed.
Controlling Access to the PHR. The PHR should give the consumer the ability to decide what information is private and to restrict access to it. A PHR vendor must get written permission to gather or disseminate the PHR. Consumers must be able to decide who else can view information in the PHR, and limit the types of information that can be viewed.
Conditions of Use. The conditions for using the PHR should be explicitly explained to consumers. Consumers must have the right to challenge their PHR vendor if it does not comply with the conditions of use. If conditions of use are changed, the PHR vendor is required to notify each consumer in writing of the changes.
Amending the Record. Consumers should have the ability to change or request changes to their PHR via email or telephone, and the telephone number of customer service must be posted on the Web site of the PHR vendor.
Account Management. The PHR provider must have a way for the consumer to terminate their account, if they wish, and to confirm that all personal data has been deleted from the system.
Document Import. The PHR system should be able to retrieve health records, explicitly label and manage personal health information and be able to distinguish between data entered by the consumer and data retrieved from other sources.
Data Availability. The PHR system should allow the consumer to view or print their health information anytime.

The president of the Center for Democracy and Technology warned about the emergence of personal health records and online privacy concerns. Leslie Harris said recent laws have strengthened privacy within the traditional healthcare systems, but Web-based sites where people store their personal health data need new protections. Extending the Health Insurance Portability and Accountability Act (HIPAA) would be a “quick fix but wouldn't be appropriate” for online personal health records, Harris added. Within HIPAA guidelines, providers can share information without getting permission from the patient, and patients do not control their information inside that “HIPAA triangle.” Storing personal health records online raises questions of access, specifically for companies with business models that will be working with advertising. Some companies are enacting protections, but rules are needed that go further than current laws, which govern only unfair and deceptive practices, Currently, there is no consumer watchdog or advocate entities in this emerging PHR marketplace. PHR vendors are disingenuous if claiming to be consumer-driven. Self-entered profile forms and internal messaging system, front-end portal or window into the health information stored in a healthcare provider or insurer's information systems is not considered a consumer-driven approach. These designs are provider-driven and the authority to determine the type and scope of information to be displayed is very limited to the consumer.

The fact remains that the information is not easily downloadable onto a portable device nor is it interoperable, that is, it cannot be integrated with any other system outside of the health plan or provider health IT enterprise. This becomes problematic for consumers when they are “out-of-network”, in travel, relocate, change insurance plans, or become affiliated with a new healthcare provider. In most cases, these PHR portals do not capture information created by other healthcare providers, and with information being provider-specific, do not have complete information about the consumer. During a personal medical emergency or disaster these PHR systems are useless, serve no function and consequently expose their limitations and are not consumer driven or beneficial.

The American Health Information Community (AHIC) 13 use cases

Between March of 2006 and March of 2008, the American Health Information Community (AHIC) published 13 use cases. In April of 2008 the AHIC began the process of identifying 2009 priorities to serve as focus areas for standards harmonization and other national Health IT agenda activities. During the June 2008 and July 2008 AHIC meetings, there was approval for development of 1 new “Use Case” and 13 “Extensions/Gaps”. One of the extensions/gaps prioritized for subsequent processing in the national health agenda activities in 2009 was Clinical Note Details. The Clinical Note Details Extension/Gap addresses the electronic exchange of standardized information related to documentation of patient encounters, visits, or services between Electronic Health Record systems (EHRs).

This final extension/gap document was developed by Office of the National Coordinator for Health Information Technology (ONC) to represent the AHIC priorities and provide context for the national health agenda activities, beginning with the selection of harmonized standards by the Healthcare Information Technology Standards Panel (HITSP). Components that need to be considered during the standards identification and harmonization activities include standardized vocabularies, data elements, datasets, and technical standards that support the information needs and clinical note processes of clinicians. HITSP may look to reuse standards, where applicable, from standards previously recognized by the Secretary of Health and Human Services (HHS), to specify and constrain how standards are to be used to advance interoperability and to work with standards development organizations to see that gaps in standards are filled.

The Advisory Task Force and the PHR Work Group are working hard to have certification accommodate all the various models for delivering personal health information to consumers, but be simple enough not to confuse the public. It is possible that there may be several ‘flavors’ of PHR certification. Some examples could include linked PHRs, independent PHRs or perhaps even PHR platforms. But again, the more we try to differentiate, the more potential for complexity and confusion. Perhaps the best thing is to determine which distinctions are absolutely imperative to make and then keep it as straightforward as possible.

### Three PHR Models

Independent Integrated Model—complete user experience to support better healthcare decisions and outcomes—EMR and other data sources
RMWC is a Independent or Untethered—Personal Health Applications=PHR platform vendor=EHR or other data source
Tethered or Linked—PHR application and connectivity offered as an accessory by an EMR Vendor or data provider=EHR or other data source compared several business models for PHI delivery. These include: 1) Consumer approach to manage health, 2) Employer and health plan approach to reduce costs and manage risks, 3) Provider approach for consumer (patient) retention, and 4) Utility service model approach to “create an ecosystem”.

As long as the PHR is accessible via web browser or other standard technology, a consumer should be able to access it worldwide. The requirements are in the categories of privacy, security and interoperability and exclude functionality.

The PHR Advisory Task Force suggested the Work Group has focused on Privacy, Security, and Interoperability for the first (09) certification year. There are only 2 functionality criteria for 09 at this point in time. They are: PHR 30.01 and PHR 31.01. “the system shall provide the ability to capture account holder provider contact information” and “the system shall provide the ability for the account holder to record his or her own health observations” respectively.

PHR and the professional medical record. The consumer should be made aware that the “vendor” of a PHR may not be the patient's health care provider, and that the certification criteria are not meant to apply to the professional provider's medical record.

There is a need to educate consumers about what constitutes a PHR. Consumers need to be explained about various sources of information brought into a PHR, and clearly differentiate between information in the PHR and the original information in a professional provider's medical record.

HL7 is working on a PHR system functional model, and has issues with the US centric definition of many PHRs developed in the US. CCHIT's definition could be a profile of the HL7 functional model definition.

The PHR Work Group is drawing heavily on the HL7 PHR functional model, but takes many other sources of information into account as well. The difference between a PHR and the personal health information that is available on a healthcare provider's patient portal? Why do the records need to be in both places?

There are several models through which patients may access their health information. The term “independent” describes PHR services offered and maintained by entities other than the individual's healthcare providers or health plans; and “linked” for PHR services offered by providers and plans (what you have called a patient portal). S of the criteria may have to be different.

We anticipate the current EHR process of a combination of documentation review, jury-observed virtual demonstration, and technical testing for EHRs will be used for PHRs as well. The certification process for EHRs brought stability and direction to a badly fragmented market and we expect the PHR process will result in the same positive outcome.

The language of ARRA and HITECH is all around interoperability as the primary driver of certification; while there is mention of other areas such as clinical decision support the overriding emphasis is on interoperability. Looking at the current CCHIT certification criteria, while interoperability is a piece of the certification pie, it is actually a relatively small piece.

CCHIT's future certification programs will be adapted to the requirements of ARRA, including rulemaking and administrative decisions made by the Secretary and Federal agencies such as ONC and CMS. Advanced Interoperability is already a certification program chosen for further development, since only 42 out of 500 criteria for inpatient certification are from the interoperability workgroup. This amount of criteria is only 10% interoperability

### SUMMARY OF THE INVENTION

In accordance with the present invention there is provided a personal a method for distribution of medical information and patient services including providing coaches to effectuate behavioral changes in patients including addressing health, wellness, mental health, and productivity issues, wherein said coaches have undertaken coach training and use substantially the same coaching skills and methodology, and wherein the coaches are as a group heterogeneous in that some of said coaches possess credentials in nutrition and weight management, and some of said coaches possess credentials in mental health.

### BRIEF DESCRIPTION OF THE DRAWINGS

These and other objects and advantages of the invention will become apparent upon reading the following detailed description of the invention and upon referring to the drawings in which:

FIG. 1 is an illustration of a preferred embodiment of a flash drive media for implementation of the present invention;

FIG. 2 is an illustration of a preferred embodiment of a card media for implementation of the present invention;

FIG. 3 is an illustration of a preferred embodiment of an alternative media for implementation of the present invention;

FIG. 4 is an illustration of a preferred embodiment of a crisis record according to the present invention;

FIG. 5 is an illustration of a laminated card according to the present invention;

FIG. 6 is a flow diagram of a customer with a record according to the present invention;

FIG. 7 is a flow diagram of a customer without a record according to the present invention;

FIG. 8 is a flow diagram of a consumer health and welfare initiative according to the present invention;

FIG. 9 is an information flow diagram according to the present invention;

FIG. 10 is a user interface according to the present invention.

While the invention will be described in conjunction with the illustrated embodiments, it is understood that it is not intended to limit the invention to these embodiments.

### DETAILED DESCRIPTION OF THE PREFERRED EMBODIMENTS

U.S. Provisional Application No. 61/199,383 is hereby incorporated in full by reference.

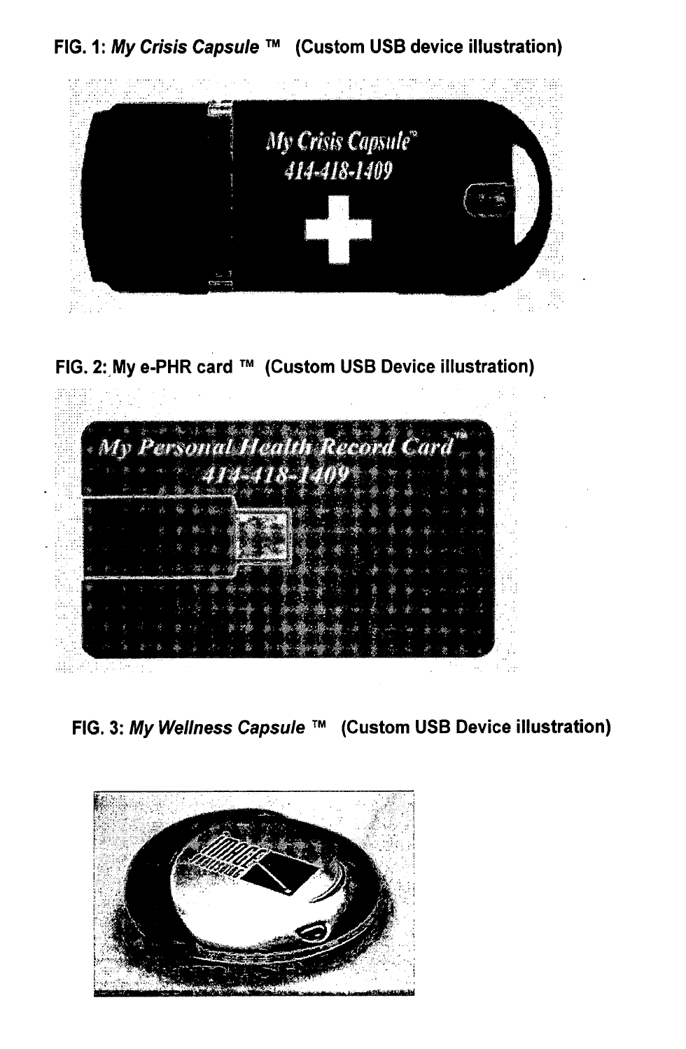

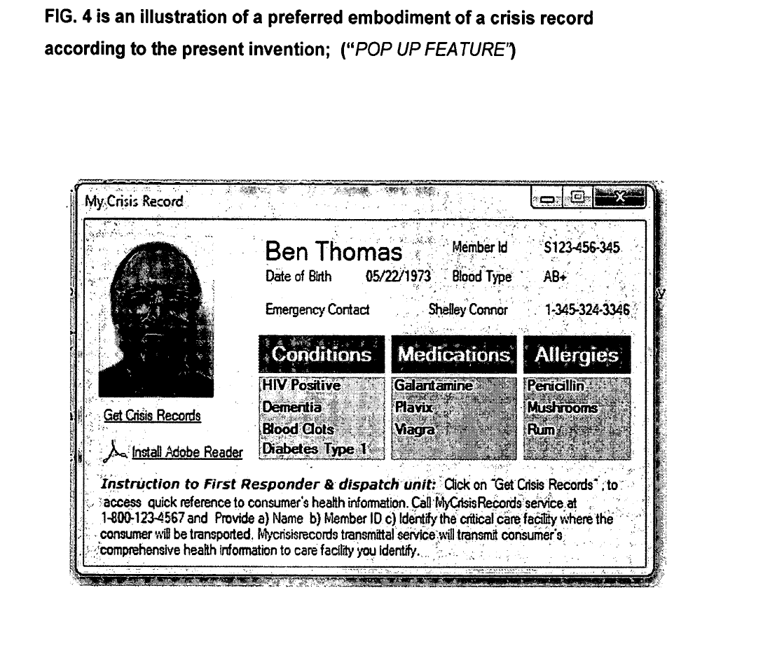

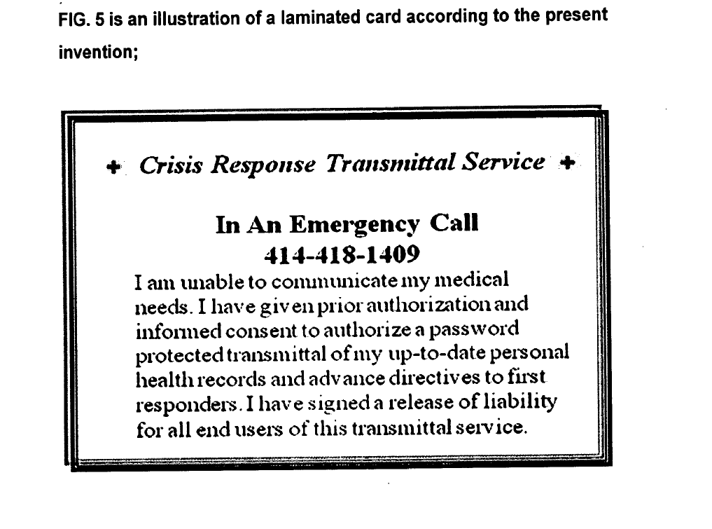

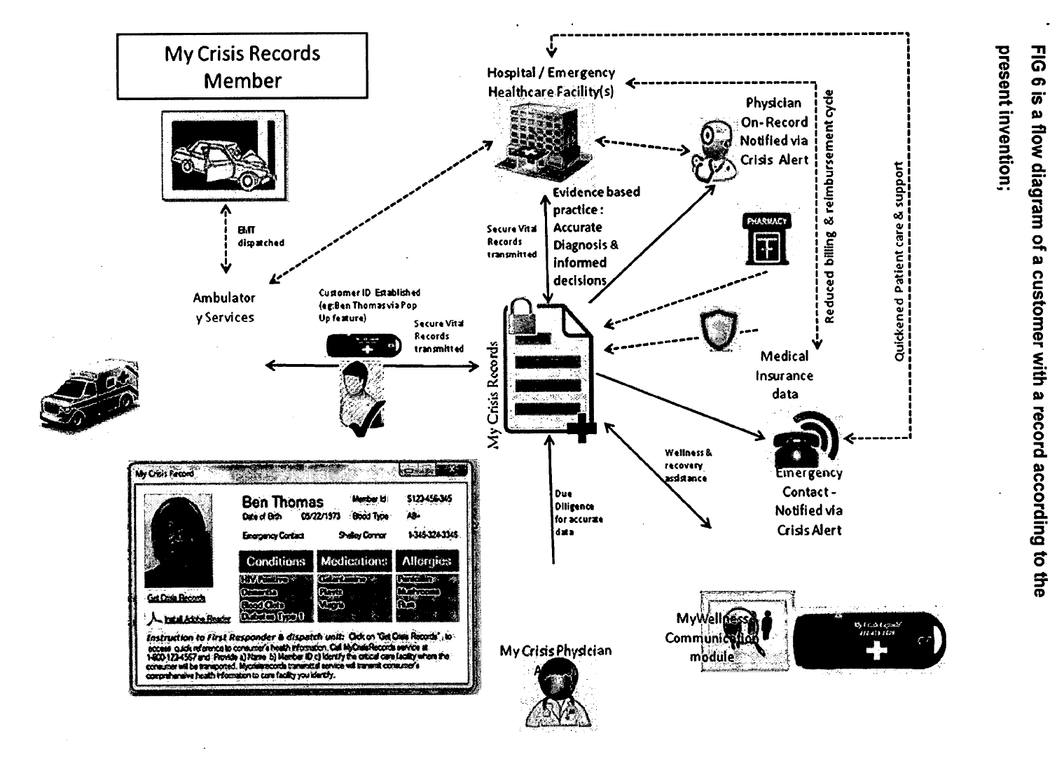

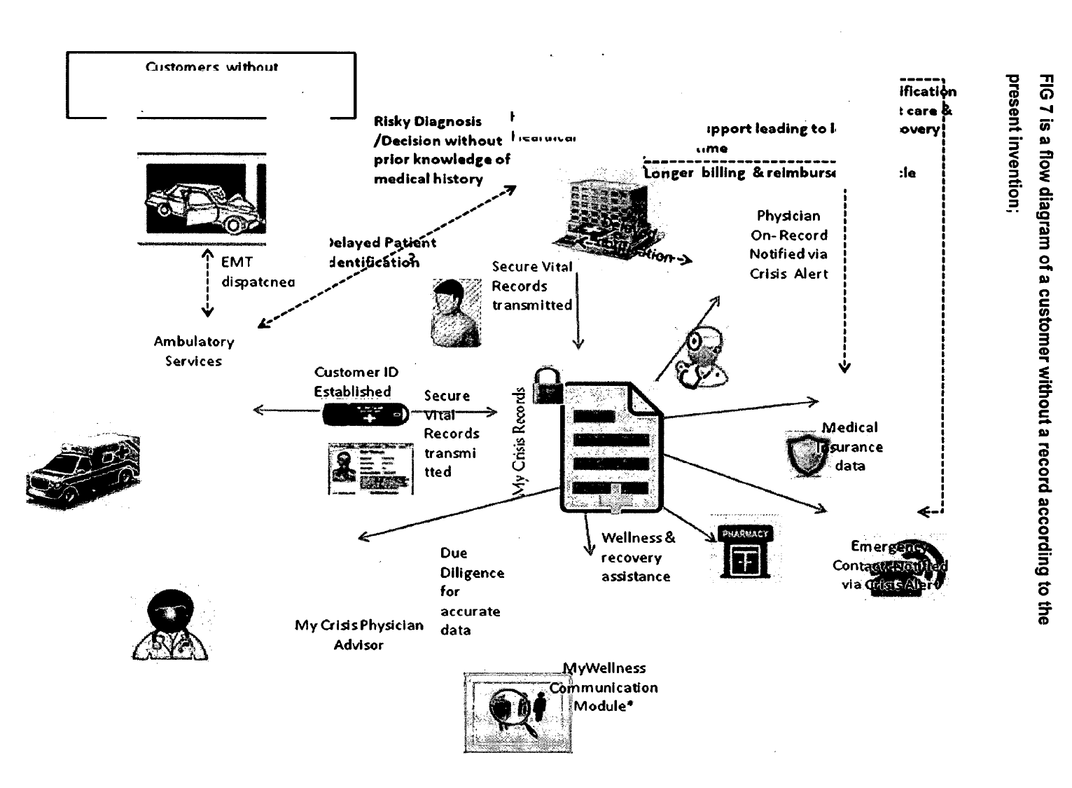

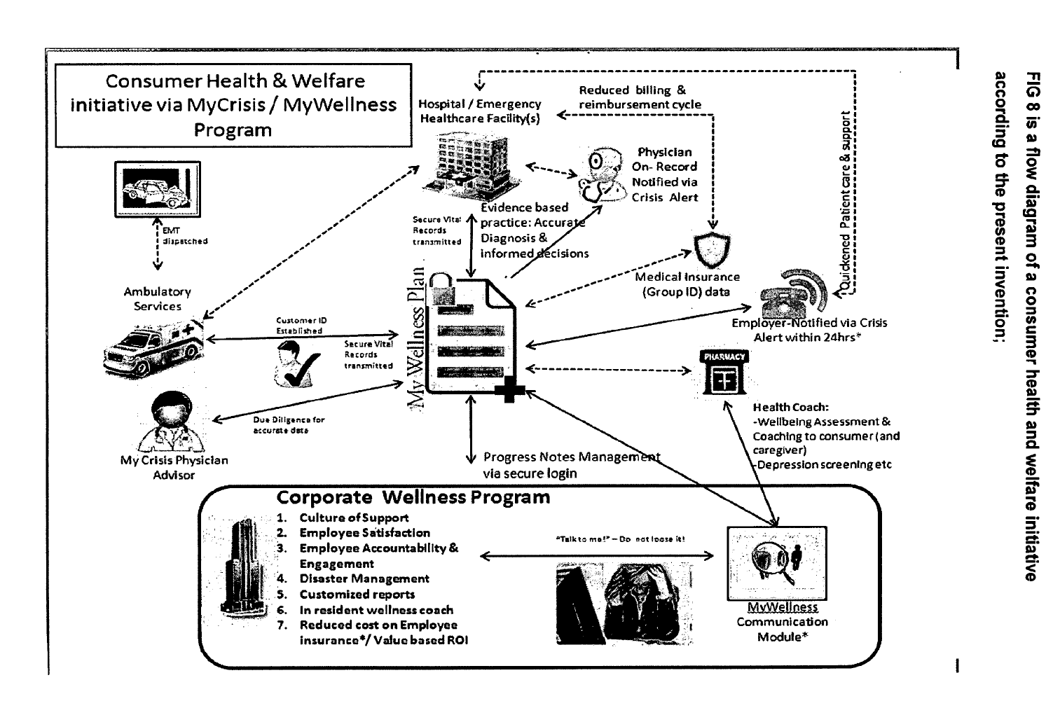

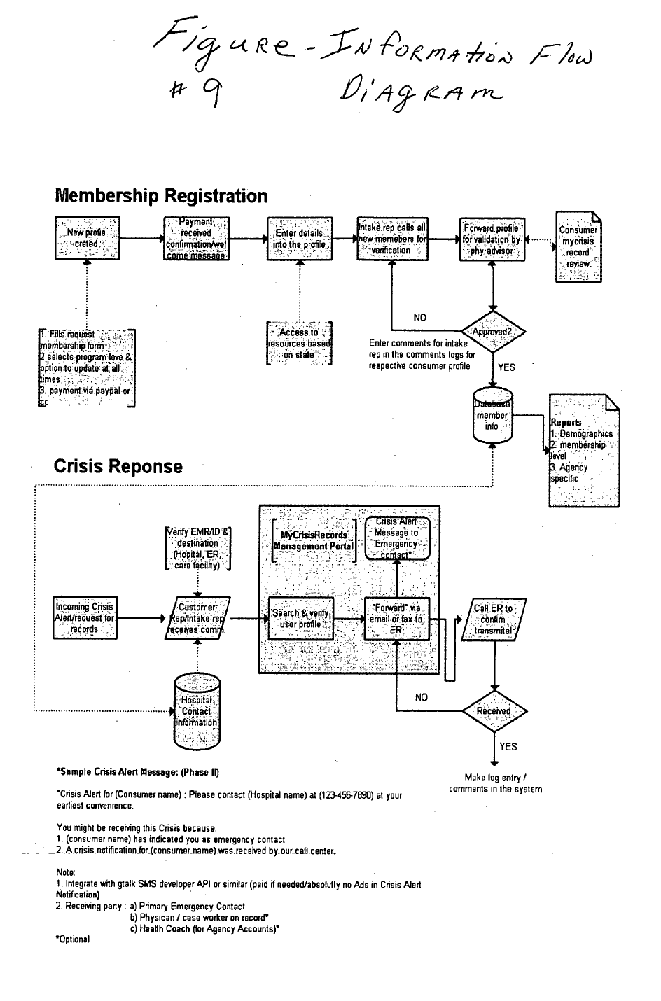

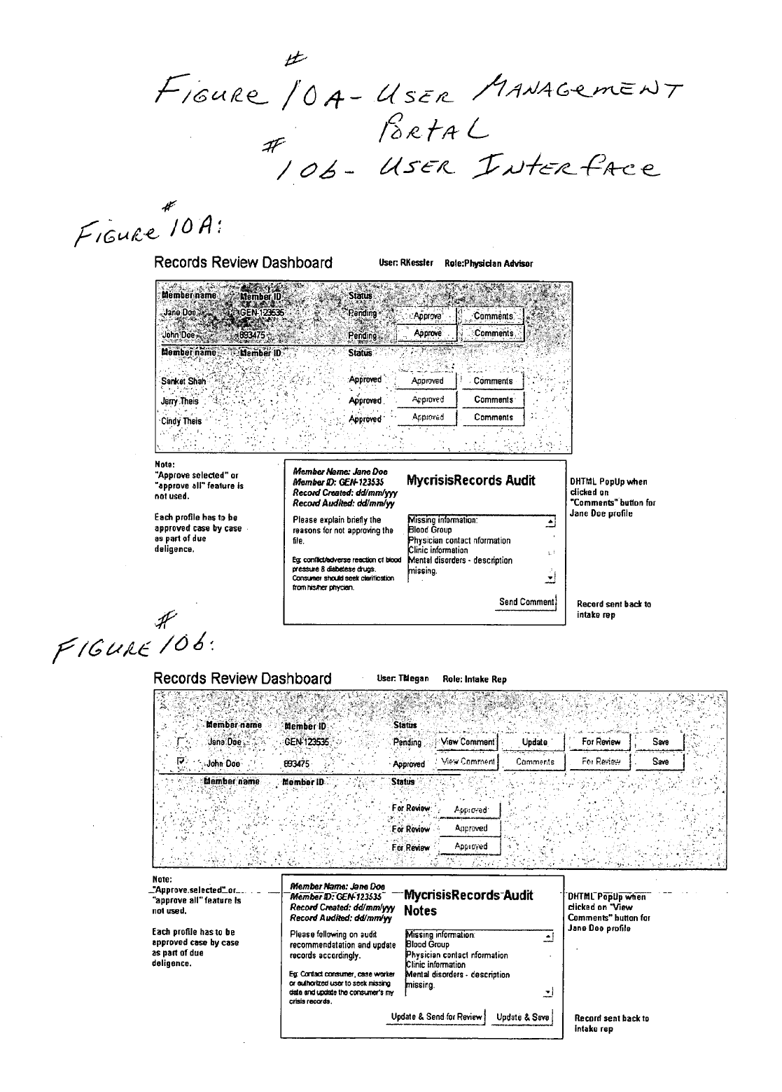

Referring to FIGS. 1-10, the present invention includes a method and system of providing an electronic personal health record.

In particular, consumers of today want better access to their personal health information and that of their families. They also want to decide who to share it with, and under what circumstances. In our electronic age, consumers can have the power to access and control their own personal health record. There are now dozens of organizations that offer systems for accumulating and storing personal health information, either online, on a personal computer, or on the computer systems of health care providers.

Certification is designed to make sure that these products meet a minimum level of security, interoperability, and functionality.

CCHIT is poised to begin a PHR certification program and will focus on security practices, uniform methods of exchanging medical information, and privacy safeguards. We believe the availability of personal health information in electronic rather than paper form will unleash one of the great opportunities of the coming decade. PHR adoption will be a significant catalyst that will advance consumer activation and empowerment. The PHR must demonstrated safeguards, as a key feature for consumers to gain acceptance of the electronic PHR. These expected safeguards will give consumers an objective assessment of a PHR's ability to protect their health data rights.

Putting personal health information in the hands of consumer's raises issues of how they get it, how and where it originates, and what they can do with it. These are among the issues raised in a recent web-based initiative seeking wide endorsement of a. These same issues have been front and center in CCHIT's development of a certification program for personal health record (PHR) systems.

The Declaration by HealthDataRights.org asserts that people should be able to access the personal health information in their medical records, know the source of the information, and share it as seen fit. The PHR is the emerging pathway for such access and control. To safeguard and protect this information, there must be a uniform set of practices and principles acceptable to consumers and objectively demonstrated by the systems receiving electronic information on their behalf.

### Engaged Consumers can Prevent Medical Errors

According to U.S. Department of health and Human services, 15% percent of all hospitalizations occur because prior medical information is not available. The PHR hold great promise for reducing adverse occurrences in the traditional healthcare settings. CCHIT's PHR certification is a parallel effort to CCHIT's work in certifying EMRs for doctors' offices, hospitals, and emergency rooms. These efforts need to be closely coordinated to make sure EHRs and PHRs will be “interoperable” (can communicate and share data) in order to avoid medical errors . . . .

An Institute of Medicine report estimates 1.5 million Americans are injured each year and 7,000 die from preventable medication errors. Medical errors are a major cause of injury and death in the United States. The now-famous 1999 report by the estimated that 44,000 to 98,000 people die in US hospitals each year as the result of medical errors. (This means that more people die from medical errors than from motor vehicle crashes, breast cancer or AIDS.)

Medical errors happen when something that was planned as a part of medical care doesn't work out, or when the wrong plan was used in the first place. Medical errors can occur anywhere in the health care system: emergency rooms, hospitals, urgent care centers, clinics, outpatient surgery centers, doctors' offices, nursing homes, pharmacies or patients' homes. Errors can involve medicines, surgery, diagnosis, equipment or lab reports. They can happen during even the most routine tasks, for instance when a hospital patient on a salt-free diet is given a high-salt meal.

Many errors are related to the complexity of today's health care systems, but they also occur when medical staff and patients have problems communicating. A recent study supported by the Agency for Healthcare Research and Quality (AHRQ) found that some doctors don't do enough to help their patients make informed decisions. Uninvolved and uninformed patients are less likely to accept the doctor's choice of treatment and less likely to do what they need to do to make the treatment work.

There has been little change in the number of deaths from preventable medical errors since the seminal report on preventable medical errors, “To Err is Human”., by a group of Hearst journalists, reports that “ten years ago, a highly publicized federal report called the death toll shocking and challenged the medical community to cut it in half—within five years. In its 2008 annual report to Congress, the Agency for Healthcare Research and Quality, a part of the Department of Health and Human Services, reported that preventable medical injuries are growing each year by 1 percent, the first time it had reported such an increase.”

As a result of this and other evidence, the Hearst journalists found that, since the original Institute of Medicine (IOM) study, there was no reason to believe that the 98,000 deaths per year attributable to preventable medical errors had declined. The report “found that the medical community, the federal government and most states have overwhelmingly failed to take the effective steps outlined in the report a decade ago.”

### What Can You Do?

1. The single most important way you can help to prevent errors is to be an active member of your health care team. That means taking part in every decision about your health care. Research shows that patients who are more involved with their care get better results. The following information is based on the latest scientific evidence about what works best.

### Medicines

2. Make sure doctors know about everything you are taking. This includes prescription and over-the-counter medicines, and even supplements such as vitamins and herbs. Make sure your medication record is updated whenever something changes.

3. Make sure doctors knows about any allergies or bad reactions you have had to medicines. This can help you avoid getting a medicine that can harm you.

### The More Information, the Better

Make sure that someone, such as your primary care doctor, is in charge of your overall care and that you're other doctors share information with your primary doctor. This is especially important if you have many health problems or are in a hospital. Make sure that all health professionals involved in your care have important health information about you. Do not assume that everyone knows everything they need to.

### Emergency Disaster Preparedness for Special Needs Populations

The 2000 US Census identified nearly 20% of the US population with disabilities. Most Web-based applications are not technically accessible to persons with disabilities using assistive technology not even factoring in sound usability design. Existing proprietary PHR products are not accessible for use by persons with disabilities.

Assuming that CCHIT is committed to making sure that PHR products “work properly and safely” for all users, accessible electronic and information technology (AeIT) criteria (such as Section 508 of the Rehabilitation Act) need to be used to address these deficits? A process to engage persons with disabilities as stakeholders in PHR usability and accessibility product testing is needed. The PHR WG has not addressed this issue to any significant degree at this time.

Emergency Preparedness for the special needs population would benefit these individuals when first responders need immediate access to their vital information particularly if their caregivers are unable to come to their aid in a disaster.

Most community's emergency responses are poor due to a lack of vital medical information on the person being accessed and treated after a disaster, or crisis. Communities must be prepared before a disaster or crisis occurs if they want to survive. Once a disaster hits it will become painfully clear that preparation and planning beforehand is much more cost effective than the interruption of a community after the fact. There are countless benefits of community planning, emergency, crisis and disaster preparation for those with special needs populations, all of which will save valuable time and resources, as well as severe stress during a disaster.

In order to maximize first responder's productivity for those with special needs the following components need to exist:
Proactive and focused approach to a communities most vulnerable population
Vital personal medical record information preservation
Improved ability to manage negative stress-related symptoms and behavior incidents during adversity
Reduce the chances of personal injuries or death for those with special needs

Community disaster preparation planning process without a focus on special needs population will lead to many severe problems that would be avoidable. If not all of the above outcomes helps to define key community processes and the impacts which would result from a disaster materializing. This enables the smart communities to be prepared for the worst and to take steps to improve the resilience of the individuals and families with special needs with a supportive community process and proactive plan. Community leadership has a duty to its special needs population and their families to plan for the continuation of and the very survival of these individuals and their families. Emergency Preparedness for the special needs populations are a crucial element of any disaster or crisis prevention and recovery plan.

Michael Steinhauser, expert consultant on special needs populations for Disaster readiness Disaster Recovery.

“The old adage about an ounce of prevention being worth a pound of cure holds true, especially when preventing and avoiding disasters. Emergency preparedness is the key to community continuity and disaster recovery. Preparing for every emergency is crucial to the minimization of the damage and community interruption following any disaster or crisis”.

Each year more than 100 million visits are made to the emergency rooms in the United States.

HITSP's Emergency Responder Use Case (which covers PHR patient data interoperability from on-scene emergency responder care through emergency room treatment) and given the fact that CCHIT states that one of the primary benefits of having a PHR is to “save your life in an emergency”, CCHIT may need to modify it's first draft of '09 interoperability criteria to reflect the PHR interoperability requirements of HITSP's Emergency Responder Use Case IS-04. The Certification Commission already certifies electronic health records used in doctor's offices and hospitals. The Commission will launch a new program for personal health records in mid-2009 that will emphasize privacy, security and the information sharing capabilities of PHRs.

### Standards and Criteria for Behavioral Health an Essential Component for CCHIT

Representatives of physical health systems currently have the strongest voice in EHR standards development, although behavioral healthcare, via SAMHSA and other entities are now more fully involved. We believe that behavioral health is a specialty requiring many unique PHR standards. While a significant overlap exists between physical health and behavioral health's data needs (e.g., similar demographic items and reasons for presenting for health care services), there are also areas in which data requirements and clinically focused functionality needs are markedly different. In addition, behavioral health rules and regulations can be quite different from those for physical health, adding variation to system needs.

The Certification Commission for Healthcare Information Technology (CCHIT) has just begun the process of reviewing personal health record software products for behavioral health and other ambulatory healthcare to determine if they meet preset standards that include content, function, and interoperability. If a software product meets the standards, CCHIT will “certify” it (The standards can be viewed at). But do these standards meet the needs of behavioral health service providers and practitioners?

The behavioral health EMR/PHR standards are complex. For example, consumer contacts occur in a variety of settings and therefore the billing codes may come from a predetermined coding based on the intensity or level of services provided. Settings in behavioral health are unique than in physical health and are provided in schools, residential placements, group homes, offices, etc. therefore, are not the same and EMR systems issues are vastly different. Physical health software systems require connectivity to other health care components of the consumers overall services such as, pharmacy, radiology, lab, physician electronic progress notes, and various ancillary health care system provider inputs). As a result these EMR systems are huge and create many different work flows.

Some of the differences in standards include:
Behavioral healthcare providers and the guiding principles for psychosocial reimbursement from CMS mandate consumer involvement, including documentation that consumers have been involved in their recovery planning, document person-centered, strength-based assessments and are engaged in Evidence-Based Practices.
In many states substance abuse services have more stringent privacy rules, even pertaining to the sharing of information with behavioral health providers. Therefore, a higher privacy and security standards are required that function differently in certain states to prevent access to the EMR related to a consumer's substance abuse.
Behavioral healthcare has a mix of funding sources with oversights such as the child protective services systems and the court systems along with county agencies. This produces more reporting work flows requiring providers to send updates to these reporting entities when information changes. In some states providers first send demographic and diagnostic information before learning which services the consumer is eligible to receive. This is a rare event in medical healthcare.
Behavioral health services and psychosocial rehabilitation services are provided by a wide range of non-credentialed individuals, such as, peer specialist, paraprofessionals and lay providers.

The software that many behavioral health agencies currently use already takes these factors into account. Thus, decision makers working on either EMR or PHR standards must consider these unique features and work flows. Software applications must ‘speak the same language’ to be able to work together. This involves creating, testing, and adopting interoperability standards that will allow systems across the health care market to move health information seamlessly. HITSP was established to be a multi-stakeholder, consensus-based body designed to provide the process where representatives from all aspects of health care select and harmonize standards to support the priorities it receives.

The sustainable capacity to develop a workforce with the skills needed to plan and deliver effective psychiatric rehabilitation services requires attention to both human resources and organizational development. In addition to presenting an approach to developing a competent workforce, examples of the application of the approach in a community residential services provider and a state psychiatric hospital will be given. Exercises and consultation will be given to provide practical information that can be applied directly to participants' issues.

Morbidity and Mortality in People with Serious Mental Illness, a 2006 report released by the National Association of State Mental Health Program Directors (NASMHPD), documents that people with serious mental illness die on average 25 years earlier than the general population and that about 60% of these premature deaths are from natural causes such as cardiovascular and pulmonary disease. The issue of poor health outcomes for people with psychiatric disabilities must be addressed by person, program, and system-level interventions if this disturbing trend is to be reversed. The goal of this institute is to help participants become aware of program interventions drawn from evidence-based practices that address specific health needs of people with psychiatric disabilities. In addition, the institute will help participants understand recommendations to address these health disparities at a system level. These recommendations are designed to increase access to and delivery of quality health care, as well as to improve the integration of health services with mental health services.

Prevention and wellness will be the key drivers determined to be effective strategies that off-set escalating healthcare cost. The United States health care system is often referred to as a sick care system as urgent and chronic illness(s) disease(s) are provided. The problem is that this is a reactive rather than a proactive approach after serious illnesses and chronic conditions develop. The United States spends a staggering $2.3 trillion annually on health care—16.5 percent of our GDP and far more than any other country spends on health care—yet the World Health Organization ranks U.S. health care only 37th among nations, on par with Serbia. US Health care cost per capita is twice as much in comparison as European countries, but United States consumers are twice as sick with chronic disease.

Systematically, the United States has neglected wellness and disease prevention. Currently in the United States, 95 percent of every health care dollar is spent on treating illnesses and conditions after they occur with little spent on wellness and prevention. By reforming our system and focusing on fighting and preventing chronic disease, there exist a huge opportunity. Hundreds of billions of dollars can be saved and a dramatic improvement in the health of the American people would result in effective wellness and preventative strategies and technologies. The PHR is one new technology that will promote and educate health-seeking consumers and will provide them with self-help wellness and prevention resources.

Seventy-five (75) percent of health care costs are accounted for by heart disease, diabetes, prostate cancer, breast cancer, and obesity. What these five diseases and conditions have in common is that they are largely preventable and even reversible by changes in nutrition, physical activity, and lifestyle.

Dr. Dean Ornish told our Senate health committee: “Studies have shown that changing lifestyle could prevent at least 90 percent of all heart disease. Thus, the disease that accounts for more premature deaths and costs Americans more than any other illness is almost completely preventable, and even reversible, simply by changing lifestyle.”

The PHR and its digital technology effort along with an emphasis on prevention and public health are necessary to change our broken health care system. Wellness and prevention must be at the centerpiece of comprehensive health reform legislation and this is an opportunity to change the paradigm

### Key Attribute of the PHR

The key attributes of a PHR is that it is governed by the consumer and will follow them over their lifetime regardless of health plan, provider, care setting, facility, or geography. However, as with any nascent product market, there is little formal definition as yet for what features or capabilities constitute a full-fledged PHR. Additionally with the wide range of approaches introduced by different players in the industry, there has been little push so far for consensus.

To help move PHR into the mainstream, we are encouraged that consumers will be offered an opportunity by IT vendors to participate by giving input what works for them and what needs they have that the PHR could serve to meet their needs. Health research organizations need to help define the role this important technology will play in peoples' lives and the potential benefits the PHR can achieve on healthcare quality, costs and outcomes.

### Benefits for Consumers

With the globalization of healthcare, it's time that individuals are able to share in the responsibility of managing the information created about them. We believe a patient-centered, value-driven approach as defined in this white paper offers many benefits for consumers as they navigate throughout the daunting health care system. This PHR approach will reduce health care cost and improve the overall quality of care. Individuals managing their own medical care know first-hand how challenging it can be to keep track of important heath records. Whether one is managing a health condition or not, the need for multiple physicians, clinics and labs makes life-saving medical information difficult to find, yet alone manage. Student populations are extremely Web-savvy, and filling out patient registration forms in a clinic waiting room might strike them as antiquated and inefficient. With a PHR digital device students can create a secure, password-protected personal health record that includes their medications, allergies, current and past conditions and other important medical information. Students could also be able to import medical information from the health center's electronic health record system into their capsule PHR after a visit to the health center then transmit their updated information to their personal hometown physician.

The health care center could also obtain survey information and answers from students to specific and other medical professionals throughout the world. Those answers could then be populated into Universities registration forms, which would be integrated into the health center's electronic health record system. This non-emergent proactive model would eliminate unnecessary delays when a student comes in for a health care visit. their overall well-being as they access healthcare services. Personalized health and disease management will be redefined.

### Benefits for Caregivers

Caregiver and/or care manager can update one's vital medical information with consent such vital information may include: allergies to foods, new health conditions, over-the-counter or herbal medications or a recent referred doctor or an added emergency contact. Keeping track of a myriad of medical information is likely a constant source of stress and frustration. Most importantly, because someone's life is at stake, caregivers need to ensure that this medical information is always current and easily available in case of an emergency. Collecting vital medical information in one place gives caregivers a comprehensive and constantly up-to-date PHR of their loved one's medical history, conditions, current medications, etc.

### Benefits for Physicians and Other Health Professionals

The PHR offers significant value to a physician in providing patient care. “The PHR provides ready access to a patient's medical history, medications, allergies, and other pertinent medical information allowing for timely decision making in assessing the patient and developing a care plan. This not only results in expeditious care, but results in better patient outcomes that not only directly benefits the patient, but results fewer medical errors, and less duplication of prior procedures and diagnostic testing; hence, more cost effective medical care. The PHR can overcome language barriers which often delay effective care and decision making processes, and gives the physician key insight into patients' involvement and understanding of their own medical conditions which is crucial.

Examples include the following:
Save administrative time and cost of having to deal with paper and paper files
Simplified response method to inquiries about patient records
Migrate from paper to electronic PHR system with ease and without losing patient information in an efficient and concise electronic format.
Standardized capture or exchange with any system for routine office visits
Store electronic PHR regardless of system compatibility
Patient and Provider upload or download files with remote flash drive
Access by Internet on a secure and private server directly to a remote computer or smart phone
Accessible during emergencies
Access by authorized persons, such as caregivers, guardians and health professionals
PHR consolidated into one view

### Benefits for Business Coalitions and Self-Funded Employer Groups

Business coalitions and health plan organizations desire to see consumer become an active participant in their care and treatment. It is hoped that the current fragmented and often described “broken” healthcare system will finally advance to a system of care that sets as a priority the following key components:
Transformation to a consumer-driven approach
Proactive planning for high-risk persons with co-morbidity
Preventative methods and strategies
Wellness-oriented promotion and services, such as wellness coaching
Supporting improved access for those with “special needs”
Mobile and interoperable personal health record
Managing safety and risk

Savings in lives and on improved patient safety will be realized by medical interventions and preventing errors. Some stories patients have experienced in emergency rooms unsettle you to your core. Maybe it's something you can't quite fathom, like a woman in the emergency room in New York last year. Esmin Green had been waiting nearly 24 hours in a New York emergency room on June 19 when she fell face down onto the floor. As captured on a surveillance video that shocked the nation, hospital staff and other patients took a look at her but did nothing for an hour. Green died.

### Value-Based Purchasing by Employers

Recently, the Center for Information Technology Leadership estimated that approximately $20 B could be saved each year in the US through the use of PHRs. And more than 70% of consumers support electronic healthcare data sharing. Increasingly, companies that want to manage healthcare costs and increase employee satisfaction are looking at PHRs as a cornerstone of their health management strategy.

We hope this paper will give insight into the PHR industry and we hope consumers and providers will begin to learn how to put personal health records to work for themselves to help employees and employers better manage and share their essential health data.
A PHR that drives an employee wellness and health promotion program is preferred.
Engaged motivated consumers generally, healthier and use health resources more efficiently, helping to manage cost
Pattern of PHR users are consistent with this pattern:
Financial impact analysis measuring decrease in modified risk show substantial projected cost savings
Medical impact estimate: $38.00-$346 per person per year
Absenteeism impact estimates: $48-169 per person per year
Preabsenteeism impact estimates: $404 per person per year

A recent report by WebMD their usage study reported the following:
Compared to users who do not visit their PHR, users who visit the PHR frequently showed a number of positive health trends*, including:
   Greater readiness to change unhealthy behavior patterns:
   7.5% increase of those in the preparedness/action/maintenance stages of change vs. 5.3% increase for control group
   Better preventative screening compliance
   Control group had a compliance rate of 8.1% higher than the control group
   Fewer missed days due to illnesses/absenteeism:
   Frequent PHR user's decreased number of missed work days by 10%, while control group increased by 33%
   Greater decreases in Depression and Stress 2.9% vs 09%; 3.3% vs. 0.5%
Note: PHR users—avg access of their PHR was 3× per month

Most employers support these fundamental principles of the e-PHR
Health care is a shared responsibility and the role of the consumer is undeniable
Employees are active partners as consumers of their health care and status; knowledgeable of their health profiles and take appropriate action how best to manage their health
Every individual deserves the highest quality care, safety and most cost-effective care.
Optimal health decisions require individual ownership of and accessibility to vital PHI/data
Individual maintenance, control and electronic access are necessary to protect confidentiality and privacy of the PHR.

### Innovation

Emerging PHR systems need to place great importance on the consumer needs without compromising functionality, security or interoperability. Innovation has already brought to the market an interoperable, remote digital PHR combined with an On Demand Crisis Response Transmittal Service™ (CRTS). This patent pended, award-winning global interoperable emergency preparedness 24/7 crisis transmittal service sends an encrypted, password protected PHR that contains the person's vital medical information and advance directives on demand to first responders and/or to the location of the emergency treatment site during a personal medical emergency or disaster anywhere anytime. Some of the unique features include:
An abundance of pre loaded wellness and health promotion content designed to encourage healthy lifestyles and then, as an optional feature
A seamlessly referral to a matched certified wellness coach based on the results of an on line well-being assessment on a private, secure web-based server.

This innovative PHR system, invented by a social worker, is considered to be the first consumer-driven PHR system focused on the consumer needs designed to engage and empower consumers with toolkits and resources for those seeking to improve their well being and health status while navigating through our daunting health care system. The unique array of patent pended, remote digital devices conveniently transform the PHR into an emergency crisis record during a medical emergency or disaster. Unlike other PHR systems the on line PHR form was crafted as a person-centered, strength-based form. This person-centered approach places emphasis on the health care consumer as a person rather than as a patient and thus, as the title of the white paper suggest, personalizes health care without compromising documentation of vital medical information, privacy, functionality or interoperability.

We may be witnessing the beginning of the paradigm shift from a provider to a consumer-driven healthcare model. Once this transformation begins it may accelerate at an unprecedented rate as advances in technology, such as smart phones become utilized as a consumer health care tool and other telemedicine technologies are introduced to the marketplace. Innovative programs will emerge so consumer will finally be positioned as meaningful members of the treatment team, bringing to the table their comprehensive personal health care record and advance directives.

We believe a well implemented, consumer-driven PHR system will-have the potential to improve health care at an acceptable cost. To enable providers and payers to make serious commitments to implementing PHR systems there will need to be real-world demonstrations of how commercially available PHR's can support improved care processes cost-effectively. Standards for interoperability and a consumer reports for PHR are both necessary and more needs to be known about cost-effective design, implementation, and technical support of PHR's.

### Challenges for the PHR/EMR

The health care industry wants a universal and standardized EMR and that there will be a consensus on a common format, criteria, standards and unified protocols. In the meantime as years go by consumers once again may fall victim to the provider-driven health care industry. Consumers already used to electronic banking and electronic buying. Consumers need to engage in this process and begin to encourage their physicians why they continue to rely on paper and their bad handwriting to prescribe and take progress notes. In the interim, innovative PHR systems such as the one described in this paper will help put more consumers at the center of their health care. A consumer-driven model will help to improve their health and wellness. Self-funded employer groups are in a position to exert influence and payers need to demand a secure and interoperable healthcare IT solution.

This collaborative model will work to expand the role for consumers. This consumer-focused business model mindset must be established to support its use. Currently this business model for-a consumer-driven service delivery in our healthcare environment is weak, except in behavioral health.

A PHR system that depends on data self entry may be questionable with regard to data integrity and reliability. Relying on the user to maintain and keep the data updated good enough? If not what are the dangers? The data entered must be readable and legible, something most firms tend to ignore, the old saying, “garbage in, garbage out.” Will these PHR vendors use internal quality controls to determine the integrity of the data prior to entry in their database?

The quality of the personal health information entered such as diagnosis, medications and other relevant medical conditions would remain independent of professional review. As such, any data entered will be subject to the user's subjective impressions and/or interpretation. Does this apparent lack of quality control compromise the reliability and validity of the information from these systems? Will it make it difficult for health care providers to use these self-report PHRs for decisions about care and interventions?

Another problem within the PHR is the lack of federal privacy protection for confidential health information stored by entities that are not covered by the Health Insurance Portability and Accountability Act. Whatever the business model for PHRs, lawmakers should require that the consumer user be clearly informed about the identity of the system's operator and the financial terms of any direct or indirect use of patient data. Stand-alone PHRs initially may be used more broadly because they will be able to serve as data intermediaries.

### Future Trends

With a projected five (5) years Compound Annual Growth Rate (CAGR) of over 50%, the PHR's worldwide market for the PHR is expected to be significant. As these remote PHR systems become broader in scale and will co-exist with EMRs and HIEs, they will offer greater consumer-driven connectivity to a variety of home medical devices and ancillary services.

Consumers will take control of their health status with these PHR systems and as a result, transform the health care system and themselves to a more engaged and knowledgeable consumer and a consumer-focused, value-driven delivery system will emerge.

During this transformation process best practices for integrating PHRs will be implemented as part of an overall population health management solution. Entrepreneurial business strategies and solutions have been and will continue to be created to optimize PHR usage, value and access and the consumer will be encouraged with incentives to drive value to the marketplace.

The establishment of privacy and information practices will be critical for the adaptation of the PHR. The data sources must be placed into a secure data repository available to multiple applications and services. This model with its portability and interoperable features will score very high in comparison to using a free web-based, commercial PHR. This in fact, is the only approach with the potential for high rates of adoption. Consumer Interest Carol Diamond of Markle Foundation's Connecting for Health organization surveyed public attitudes towards Personal Health Records (PHR). Markle's survey found only 13.5% of respondents very interested in using a free commercial web-based PHR and another third somewhat interested.

### Recommendations

The upcoming PHR certification process needs to be a combination of documentation review, jury-observed virtual demonstrations, technical testing and include the DIRECT INVOLVEMENT OF THE CONSUMER with meaningful input with strong representation.
There is a need to educate the consumer and provider about what constitutes a PHR. The consumer should be made aware that the “vendor’ of the PHR may not be the consumer's health care providers and that the certification criteria are not meant to apply to the professional provider's medical records.
Current Proprietary EMR/PHR products need to accessible for use by persons with disabilities
Greater emphasis must be placed on interoperability. The 500 criteria for the EMR of inpatient certification for example, had only forty-two (42) interoperability criteria.
Behavioral health considerations identified in this paper need to be addressed to fit behavioral health provider systems and work flows
We need powerful financial consumer and provider incentives—such as a pay-for-performance—that will reward organizations for using PHR's to improve the quality and efficiency of U.S. health care. For consumers, incentives for those who seek out wellness initiatives that sustain healthy lifestyles through behavioral change would be a step in the right direction, a step facilitated by a progressive PHR system.

### Conclusion: A Full E Health System

The PHR is one of many challenges faced in the implementation of a full ehealth system to improve illness prevention and safety of care facilitated by the engaged and empowered consumer. New opportunities in personalized health and disease management will emerge like the remote digital and interoperable on demand transmittal service designed to reduce cost and medical errors during a medical emergency or disaster event.

It is imperative in order to improve our fragmented healthcare information “system” consumer empowerment and engagement are necessary to facilitate this transformation movement in which the consumer plays a proactive and meaningful role, a crucial piece of the EMR/PHR systems. The ability to exchange clinical information between hospitals and practices by connecting the physician EMR and system with hospital IT systems will take along time. An EMR is like a train without railroad tracks it doesn't have the same function. You have to build railroad tracks before you build the train and load it with passengers. We are not done building the tracks yet, so it does not have an integrated system. Many parts and railroad stations exist but we need to connect the dots in order to function and have real value all stakeholders. Each region of doctors and hospitals need to be on the same system before a full E health system can become the desired product then it can be expanded to other regions. There are many variables to having an electronic record and it involves more than just putting records online.

The new administration is firmly behind initiatives that foster healthcare IT consumer adoption, and funding for these kinds of efforts is included in the stimulus package. Offering personal health records holds the key and will improve care and reduce cost.

The key attributes of an independent and remote PHR system model is that it is governed and owned by the consumer and will follow them over their lifetime regardless of health plan, provider, care setting, facility, or geography. However, as with any nascent product market, there is little formal definition as yet for what features or capabilities constitute a full-fledged PHR. And, with the wide range of approaches introduced by different players in the industry, there has been little push so far for consensus.

Individuals managing their own medical care know first-hand how challenging it can be to keep track of important heath records. Whether one is managing a health condition or not, the need for multiple physicians, clinics and labs makes life-saving medical information difficult to find, yet alone manage. A PHR driven by the consumer in one organized, private secure web-based server organized in a relational data base for simple access as a data source for their personal health information—constantly-accurate and kept up to date will enhance quality health care.

Caregiver and/or care manager can update one's vital medical information with consent directly into the password protected web server at anytime. Such vital information may include: allergies to foods, new health conditions, over-the-counter or herbal medications or a recent referred doctor or an added emergency contact. Keeping track of a myriad of medical information is likely a constant source of stress and frustration. Most importantly, because someone's life is at stake, caregivers need to ensure that this medical information is always current and easily available in case of an emergency. By collecting vital medial information in one place gives caregivers a comprehensive and constantly up-to-date PHR of their loved one's medical history, conditions, current medications, etc.

We believe a well implemented, consumer-driven PHR will-have the potential to improve health care at an acceptable cost. To enable providers and payers to make serious commitments to implementing PHR there will need to be real-world demonstrations of how commercially available PHR's can support improved care processes cost-effectively. Standards for interoperability and a Consumer Report for PHR are both necessary and more needs to be known about cost-effective design, implementation, and technical support of PHR's.

Future PHR systems need to place great importance on the consumer needs without compromising functionality. Innovation has already introduced to the market and it is out hope other innovative programs will emerge enhanced digital technology.

Powerful financial consumer and provider incentives—such as a pay-for-performance—that will reward organizations for using PHRs to improve the quality and efficiency of U.S. health care. For consumers, incentives for those who seek out wellness initiatives that sustain healthy lifestyles through behavioral change would be a step in the right direction, a step facilitated by a progressive PHR system. The government is offering financial incentives for doctors and hospitals to add or upgrade their technology systems.

Record keeping may have evolved, but you do not have to be in healthcare too long to realize that it is still a medieval cottage industry. Highly protective walls have been building by stakeholders who either have no incentive to share data nor do they have the capability. Key challenges include making the information systems “interoperable” and protecting patient privacy. Consumers already used to electronic banking and electronic buying, will be encouraged to ask their physicians why they continue to rely on bad handwriting to prescribe.

A private non commercial web-based PHR is defined as an extension of physicians' electronic health records. A stand-alone, non-public on line PHR is an Internet-based tool for consumers. We believe that the more access provided, the stronger the partnership that will be cultivated between consumers and clinicians. A PHR offers convenience, a way for physicians and consumers to co-create a shared personal health record and formulate a shared treatment plan.

An expanded role for the consumer and a consumer-focused PHR business model will enhance collaboration. Currently this business model for-a consumer-driven service delivery in our healthcare environment is weak and must be strengthened.

Another challenge within the PHR is the lack of federal privacy protection for confidential health information stored by entities that are not covered by the Health Insurance Portability and Accountability Act. Whatever the business model for PHRs, lawmakers should require that the consumer user be clearly informed about the identity of the system's operator and the financial terms of any direct or indirect use of patient data. Stand-alone PHRs initially may be used more broadly because they will be able to serve as data intermediaries.

With the globalization of healthcare, it's time that individuals are able to share in the responsibility of managing the information created about them.

We believe:
Quality health care requires access to vital medical information.
Consumer driven as opposed to provider driven information technology.
Privacy, security, confidentiality and on line access to the PHR are paramount.
PHRs are the “silver bullets” that will accelerate consumer empowerment throughout the global the healthcare delivery systems.
Consumer empowerment and engagement will result in the utilization of the PHR as consumers and caregivers will become actively involved in their own and their family's health status and health care.
Use of the PHR will lead to knowledge-based assessments and improved clinical outcomes.
Access to the PHR during a personal medical emergency or disaster will reduce cost, adverse events and save lives
Consumers need an interoperable PHR
The PHR will dramatically improve efficiency of care for providers and financial outcomes for payers and consumers.
Caregivers will have “peace of mind” knowing the loved one's PHR is accessible to emergency responders wherever and whenever they need emergency medical care.

Background on devices:
My Crisis Capsule™ the patent-pended personal emergency digital devices
My e-PHR Card™ an on line personal health record card on a private, secure web based server
My Wellness Capsule™—an optional seamless referral to over 3,000 certified wellness coach throughout the world

The transmittal program is described below with its novel key features:
On Demand Crisis Response Transmittal Service™ (CRTS). An award-winning global interoperable emergency preparedness 24/7 crisis transmittal service that transmits an encrypted, password protected digital Personal Health Record (PHR) file that contains the person's vital medical information and advance directives on demand to verified first responders and/or to the location of the emergency treatment site.

Key Features
Interoperable—Anywhere Anytime
On Demand and Immediate Transmittal
PHR maintained and updated routinely by professional staff
Stored in a private secure web based server with no third party affiliation
Transmittal is password protected and encrypted

This On Demand Crisis Response Transmittal Service is a prominent component of this claim application since it's method of transmitting one's PHR on demand is unique, novel, functional and interoperable. The scope of this innovative service is global. This transmittal service is operational anywhere anytime using the most advanced speed of global transmittal in the wireless industry. Consider how powerful this emergency medical crisis preparedness digital transmittal service is during the most vulnerable episodes in the continuum of health care, the emergency room or trauma center. There are a number of “cues” for trained first responders to locate the instructions to ca to activate the On Demand transmittal service. These various cues include: pre loaded instructions in the digital device that pops-up when the device is inserted in any USB port on any computer. Also, the phone number of the transmittal service is engraved on the device, a laminated crisis card and a laminated crisis tag is attached to the key chain on the device are all included in the patent application design. These methods describe all of the cues that instruct first responders during a personal medical emergency or disaster. This novel design is a very critical feature when someone is disabled, unconscious or without their digital device during an medical emergency event.

Supported by a secure, private, non-commercial web-based server independent of any third-party affiliates, or special interest groups, provides the highest security and privacy standards in the IT healthcare industry. RMWC technology supports a personalized service for health care consumers attempting to navigate in a provider-driven IT environment and daunting health care system.

Each array of digital devices includes as a standard feature, an abundance of self-help toolkits and resources which promote healthy lifestyle and problem-solving skill development.

The digital devices and transmittal technology includes the following:

### Corporate Principle Beliefs and Vision:

Our principle belief is when consumer seeking health care are empowered with consumer-driven digital technology they will significantly impact their health care cost and enhance their well being as they navigate through the daunting health care system. As a result of this principle belief and vision we then etched a paradigm shift to a consumer-driven IT business model in a provider-driven IT healthcare industry. Driven by our passion for consumer empowerment and activation is the essence that inspired the creation of our products and services.

The founder, a visionary social worker realized the IT health care industry had unleashed Electronic Medical Records (EMR's) with little if any consideration or input from consumers with “special needs.” Consequently, the social needs for these vulnerable consumers have unintentionally fallen short while a provider-driven electronic medical record system emerged. Our business planning remained focused on the consumer which resulted in an “on demand” electronic Personal Health Record (PHR). Our patent pended multi-purpose design went well beyond the compliance standards of The Certification Committee for Health Information Technology (CCHIT).

### Ten (10) Corporate Beliefs:

Consumer driven as opposed to provider driven information technology.
Privacy, security, confidentiality and on line access to the PHR are paramount.
PHRs are the “silver bullets” that will accelerate consumer empowerment throughout the global the healthcare delivery systems.
Consumer activation will result in the utilization of the PHR as consumers and caregivers will become actively involved in their own and their family's healthcare.
Use of the PHR will lead to knowledge-based assessments and improved clinical outcomes.
Access to the PHR during a personal medical emergency or disaster will reduce adverse events
Consumers need an interoperable PHR available 24/7.
The PHR will dramatically improve efficiency of care for providers and financial outcomes for payers and consumers.
Caregivers will have “peace of mind” knowing the loved one's PHR is accessible to emergency responders wherever and whenever they need emergency medical care.

### Background of the Personal Health Record

From the mid to late 1990s, a number of Internet companies have emerged to provide health information to consumers in the form of health regimens, disease-specific content or “health journals.” In the course of this growing trend toward self-help tools and consumer activism, a number of internet firms introduced online health information forms where consumers could record their health conditions, medications and medical history. These forms evolved as did the firms from a basic intake sheet similar to the forms a patient completes on their first visit to a doctor's office) to elaborate all inclusive in-depth health status questionnaires that are either disease specific or for monitoring health condition(s). These web-based forms collect personal health information self-entered or entered by one's caregivers on behalf of the patient that details their medical history, current medications, conditions, and other health related services and treatments.

Some firms provide e-mail exchange to authorized sources, such as a doctor's office sending the data to the referred specialty clinic prior to the scheduled appointment. Other firms save the information onto their web-based server and others offer their member a portable device such as a flash-drive for their members to have remote access to their personal health information. Usually, the web-based system exists separately and independently from the healthcare provider's information systems known as Electronic Medical Record (EMR). As such, they came to be described categorically as “stand-alone” personal health records, or PHR.

### The Current PHR Market:

At first glance, these PHR firms seem to offer a major benefit for health care consumers by empowering them with full control and privacy. However, without an interoperability component a consumer will not have their vital medical information” in the hands” of emergency physicians unfamiliar with one's medical conditions during a personal medical emergency. What may follow could be an adverse event, such as those reported in the latest Institute of Medicine Report on Emergency Rooms

At second glance, do all of these benefits and advantages really exist? They do come with inherent challenges like most health care initiatives? In order to preserve data integrity reliable does a PHR system that relies only upon the self-enter user to maintain and keep the data updated good enough? If not what are the dangers? The data entered must be readable and legible, something most firms tend to ignore, the old saying, “garbage in, garbage out.”

Will these PHR vendors use internal quality controls, such as a physician concurrent review process to determine the integrity of the data prior to entry in their database. The quality of the personal health information entered such as diagnosis, medications and other relevant medical conditions would remain independent of expert review. As such, any data entered will be subject to the person or their designated authorized user, such as their caregiver's subjective impressions and/or interpretation. Does this apparent lack of quality controls compromise the reliability and validity of the information from these systems and makes it difficult for health care providers to use these self-report PHR for decisions making about care and intervention?

Our consensus through our research in the PHR marketplace concluded there is no consumer watchdog or advocate entities in this emerging PHR marketplace. Similar to most provider-driven healthcare vendors do when there is profit opportunity. Both, the stand-alone EMR and PHR systems and the insurer-based claims systems that call themselves PHR are disingenuous if claiming to be consumer-driven. They do offer more than self-entered profile forms and internal messaging system. They provide patients with a front-end portal or window into the health information stored in a healthcare provider or insurer's information systems. These (portals) are designed and usually paid for by the healthcare providers or insurers, and indirectly through higher premiums imposed on their members. These models are provider-driven and the authority to determine the type and scope of information to be displayed is very limited to the consumer.

The fact remains is that the information is not easily downloadable onto a portable device nor is it interoperable, that is, it cannot be integrated with any other system outside of the health plan or provider health are IT enterprise. This becomes problematic for consumers when they are “out-of-network”, in travel, relocate, change insurance plans, or become affiliated with a new healthcare provider. In most cases, these PHR portals do not capture information created by other healthcare providers, and with information being provider-specific, do not have complete information about the consumer. During a personal medical emergency or disaster these PHR systems are useless serve no function and consequently expose their limitations and are not consumer driven or beneficial.

With no true consumer advocate entity in this emerging industry this will only escalate the sense of loss of control and uncertainty already experienced by the confused and powerless healthcare consumer during these unsettling times of health care reform.

The intellectual property is the result of the inventor's passion for creating a consumer-driven model within the healthcare system. That being said, this is the first consumer-driven healthcare digital device that empowers consumers who are attempting to navigate through the fragmented healthcare system. More importantly, the inventor, a social worker with over 33 years of experience designed these programs for the elderly, persons with high risk medical conditions and persons with “special needs.

The invention is a multi-dimensional design that included vital medical information that is person-centered, an advance directive, an abundance of self help wellness and health promotion toolkits, resources and links pre loaded in each digital device combined with an On Demand Crisis Response Transmittal Service. In addition, there exist a seamless referral to a certified wellness coach and the private, on line PHR is interactive with a self-help library and other on line features.

The patent pended multi-purpose design went well beyond the compliance standards of the Certification Commission for Healthcare Information Technology (CCHIT). This revolutionary transmittal technology functions globally and is accessible immediately anywhere anytime using the most advanced speed of global transmittal in the wireless industry.

### Empowerment and Self-Efficacy—Primary Principles and the Essence of the Invention

Involvement in one's own medical care also involves the closely linked concepts of patient empowerment and self-efficacy. In general, empowerment can be thought of as the process that enables people to exert control over their lives and their destiny. It is closely related to health outcomes in that powerlessness has been shown to be a broad-based risk factor for disease. Studies demonstrate that people who feel “in control” in a health situation have better outcomes than those who feel powerless. Similarly, self-efficacy is a person's level of confidence that they can perform a specific task or health behavior in the future. Clinical studies show that self-efficacy can be most predictive of improvements in patients' functional status. Perceived self-efficacy was shown to play a significant role in smoking cessation relapse rate, pain management, control of eating and weight, success of recovery from myocardial infarction, and adherence to preventive health programs.

An important measure of success is how well we promote empowerment and self-efficacy for our participants. Empowerment can be enhanced, for instance, by online support groups that allow participants to feel “connected” to others with a similar medical problem. This has been demonstrated in women with beast cancer and patients with AIDS.

This is a new and emerging field with significant innovations in the commercial sector. Research in several area are needed to move the field forward in providing real benefits to individuals health outcomes and in showing the effectiveness of the systems to purchasers of health care. Careful needs assessment before system development, usability testing during development, controlled clinical trials, and studies of use and outcomes in natural settings are all critical to our understanding of how best to provide health information and decision assistance to participants.

Advances in communications and information technology will change the way in which medicine is practiced, and it will also change the way in which participants receive information and interact with the new health care delivery system. The future holds great promise for consumers becoming empowered and active participants in their medical care decisions. The people outside of the formal medical setting make the vast majority of health-related decisions.

### Background of the Inventor

The inventor's principle belief is when consumer seeking wellness and health care are empowered with consumer-driven digital technology they will significantly impact health care cost and enhance their well being as they navigate through the daunting health care “system”. This consumer-driven business model is the essence and passion that inspired the creation of these products and services. As digital technology become main stream in our global health care industry he envisioned an OPPORTUNITY to add value and convenience for consumers so their needs would be considered as this emerging technology unveils itself in the marketplace.

The inventor is:
A visionary and social worker who realized the IT health care industry had unleashed Electronic Medical Records (EMR's) and Personal Health Records (PHR's) without any consideration or direct input from consumers with “special needs.” Consequently, the special needs for these vulnerable consumers have unintentionally fallen short while a provider-driven electronic medical record system emerged.

The inventor realized:
A person with “special needs” is more vulnerable during a personal medical emergency or during a disaster event. In these critical situations, there lacks a systemic method, product and global. interoperable digital technology program that effectively communicates any person's needs even when the person were unconscious or unable to communicate during an emergency medical event or disaster. Since their PHR are transmitted during a medical emergency, this proactive program using digital technology and the combined on demand transmittal services was the primary intent of the invention. Special needs populations are most vulnerable in our society during a disaster or personal crisis event and therefore this invention was created to fill the void existing in emergency preparedness planning. The creation of the web based server and the data base where the vital information is stored then transmitted in a password encrypted manners to first responders during an emergency is a novel idea.

The inventor is a:

Consumer advocate for the health care seeking consumer who has empowered them with a digital tool during a time when our society transforms to a society living in an ever growing digital lifestyle.

The inventor:

Wants to redefine the definition of pro activity in crisis management and wants to “raise the bar” and awareness for those with special needs during a personal medical emergency. There is a compelling need for a higher standard of emergency responsiveness for all health care consumers. Consumers need to be empowered with their advance directives and vital medical information during a personal medical emergency.

The inventor:

Emphasizes self-help prevention and wellness as key values within this innovation.

### The Products/Services:

### Detailed Description of Each Unique Digital Device

This is a proactive emergency preparedness toolkit for consumers and for first responders Emphasis on self-help prevention and wellness are key values within this innovative consumer-driven model. We believe there is a tremendous void in our provider-driven healthcare system. There are no consumer-driven, proactive programs or “toolkits” that combines a remote and digital Personal Health Record (PHR) with advance directives, a crisis response transmittal service within a remote digital prevention and wellness information and resources. This is a ‘breakthrough” that will have a profound impact on emergency crisis medical responsiveness and on consumer healthcare empowerment. Healthcare consumers will finally be empowered with their vital medical information and advance directives where as before, they had virtually no means to achieve empowerment during their most vulnerable moments during an emergency.

A variety of stylish digital devices are available so one can choose the style and features that meet someone's unique needs.
My Crisis Capsule™ A PHR stored on a private, secure web site server not in the digital device. This emergency preparedness device combined with the CRTS was designed for the most vulnerable populations, those with special needs, the elderly and those with high-risk medical conditions.
The digital device is pre loaded with an abundance of self help resources for patients and caregivers. A complimentary laminated Crisis Card and a laminated crisis tag is included giving first responders other sources to contact the CTRS. Consider how powerful this program can be during the most vulnerable episodes in the continuum of care, a personal medical emergency event.

### My Crisis Capsule™

A PHR designed for the most vulnerable populations, those with special needs, the elderly, those with high-risk medical conditions and for their caregivers. My Crisis Capsule™ is idea for persons with “special needs” Having vital medical information and via transmittal empowers consumers even if they are unconscious or unable to communicate their wishes during these critical decision-making episodes.

What is it?
A digital device that alerts and instructs first responders to call the transmittal service with it's distinguished red color capsule and engraved white cross and phone number of the transmittal service.

### Primary Purpose:

Allows first responders and emergency medical professionals immediate access to one's vital medical information and advance directives
Emergency hospital personnel use this data to perform a knowledge-based assessment and efficient decision-making

My Crisis Capsule™ places the vital medical information on a private, secure web based server not in the device. This provides for a single secured storage of one's up-to-date vital medical information and advance directives accessible anytime anywhere. The consumer as a member of the transmittal service pays an annual membership fee to store and for the firm to routinely update the vital medical information then transmit On Demand.

The value-added remote digital device is pre loaded with an abundance of self-help wellness and preventative “toolkits” designed to empower and encourage healthy lifestyles with an optional service to a seamlessly referred to a certified wellness coach: This innovative feature transforms the device therefore, into an educational toolkit. Another unique feature is its method of facilitating a seamlessly referred to a certified wellness coach.

This designed USB device:
Empowers consumer with a sense of security and control
Enables first responders to immediately realize existing medical conditions, social needs, prescriptions, and other vital information such as:
   Medical Conditions and Symptoms
   Allergies
   Medication Side Effects and/or Complications
   Blood Type
   Advance Directives

### The Electronic Personal Health Record Card:

My e-PHR Card™

An on line PHR on a private, secure web based server. at: allows the patient or caregiver to input their vital information and advance directives then download the data onto a digital device styled like a credit card. The device is pre loaded with an abundance of self help toolkits, resources and links that promote wellness and healthy lifestyles. The CRTS can be activated by first responders when the person is unconscious or unable to communicate during a personal medical emergency. Having vital medical information transmittal empowers consumers even if they are unconscious or unable to communicate their wishes during these critical decision-making episodes.
Mobile, convenient and interoperable digital device
Digital exchange prior to office visit or clinical encounter with physician's and/or specialist referrals
Travel aid device during illness and/or treatment services
Transmits to local emergency room before arrival
Avoid paperwork and delays
Self maintained and updated by consumer on the secure password protected web site that consumer rents
Self-help resources and toolkits
Optional Services includes:
   24/7 Crisis Response Transmittal Program
   Seamless Referral to Certified Wellness Coach

### Program Facts and Features

Card inserts into any computer anywhere
Contains current prescribed medications, health provider's information, medical conditions, allergies, etc. are updated by you and your provider(s)
Useful for routine physician or specialty appointments by sending PHR prior to appointment then update the PHR after the appointment
Stored on your password protected secure digital device and on the Web
Empowers consumers to partner with their physician keeping them appraised of current health status by sending a transmit to physician before your appointment then exchanging data after appointment
Avoids delays and unnecessary paperwork
Promotes and encourages physicians to use electronic medical records
Adheres to the federal mandate for the use of an electronic medical record

Travel aid during vacation travels when in need of non-network medical services within or outside of the United States
Allows emergency medical technician (EMT) and/or emergency room access to your vital information in a medical emergency
When away from home or when determined to be “out-of network” by the health plan the potential exist to avoid unnecessary diagnostic testing and costly medical expenses during an emergency event
Medical personnel immediately understand your existing medical conditions to enhance their knowledge-based assessment and intervention
Empowers consumers with an abundance of prevention, wellness and self-help resources and toolkits to encourage a healthy lifestyle
Listing of local crisis and community resources

Care managers, home health nurses, etc. can download data for “special needs students” during home visits Innovative products such as Web-based e-PHR card help put more patients at the center of their care. Employees will be able to send medical information that is documented in the e-PHR card before a clinical encounter to their referred physician for inclusion in their personal health record. Web based e-PHR card is a key component to help improve the health and wellness of its own people. As one of the most innovative technology companies in the world, invest in secure, patient-centered and interoperable healthcare IT solutions.

This device functions as an interoperable PHR. Patients can transmit their PHR to the medical clinic and the clinic can use the device to exchange and update records after each visit as well as maintain notes from specialist referrals. The PHR could also be transmitted to a referring physician prior to the initial appointment.

### Key Features & Benefits

Mobile, convenient and interoperable digital device
Electronic exchange prior to office visit or clinical encounter with physician and/or specialist referrals
Travel aid device during illness and/or treatment services
Downloads PHR at the emergency room
Avoid paperwork and delays
Self maintained and updated by patient
Secure password protected interactive web site
Contains self-help resources and toolkits

### My Wellness Capsule™

My Wellness Capsule™ is unique and distinguishes itself by its ability to transform into either a PHR, self-help wellness toolkit or serve as a seamless referral mechanism to a certified wellness coach. An optional feature of this unique custom designed digital device is its use as a as a proactive emergency preparedness device during a medical emergency. The device can be self transmitted to first responders or in the case of the person being unconscious therefore unable to communicate their password to access the vital information, the first responder can call the CRTS to receive access to the interoperable vital medical information anytime anywhere.

A PHR with an option fort a seamless referral to a personal certified wellness coach. The referral process is strictly confidential and matched based on the identified wellness needs report from a brief on line well-being assessment. The report, a color graph is displayed on the computer screen or smart phone and transmitted to the assigned coach. The coach reviews the report prior to the initial 60 minute telephone session. At the conclusion of the session a co-created wellness plan is completed. Shortly following the session the coach transmits the written plan to the patient.

Interoperability is defined as the ability to share single format patient health record, between multiple health care facilities that have existing and different clinic/patient records management IT systems. Therefore the Wellness Capsule empowers wellness-seeking and health-seeking individuals since the capsule contains password protected vital medical information for digital exchange of information with health care providers. Each device can serve as an efficient Electronic Medical Record (EMR). Physicians and clinic staff can use the device to exchange and update records after each visit as well as maintain notes from specialist referrals. The EMR could also be emailed to a referring physician prior to the initial appointment. Individuals can update their PHR online anytime from the secure password protected data base.

My Wellness Capsule™ is designed to maximize well-being and overall functioning with its abundance of self-help content designed to promote wellness, prevention and healthy lifestyles. These unique features and services transform the device into a personal emergency preparedness device allowing first responders immediate access to one's vital medical information.

Because this device has pre loaded self-help wellness toolkits, resources and links to assist and empower persons this value-added feature serves as a self-help educational toolkit intended to encourage positive healthy lifestyle and behavior change.

There is an optional feature is a seamless referral to a certified wellness coach The referral is matched based on the results of a completed on line well-being assessment. Once the person completes the assessment the results are displayed in “real time” when the colored graph appears on the computer or smart phone. The completed survey is automatically transmitted to a wellness coach matched to the consumer based on the coach specialty and the consumer's wellness needs determined by the questionnaire.

The wellness categories include the following: fitness, nutrition, weight management and stress. The matched wellness coach now prepared having reviewed the questionnaire results calls the consumer and performs a 60 minute telephone session, completes the co-created wellness plan and submits a written wellness plan to the consumer soon after they complete the telephone session.

The consumer becomes empowered through the use of this digital device to access a wellness coaching session and a wellness seeking person can seek and reinforce ways to pursue their wellness plan by reviewing, at their convenience, the abundance of pre loaded self-help content loaded in the digital drive. Also, the consumer can access and download more information from the web site to personalize their self help digital library.

Both My e-PHR card and My Wellness Capsule contains vital medical information for digital exchange of information with health care providers. Each device can serve as an efficient Electronic Medical Record (EMR). Consumers, physicians and clinic staff can use the device to update records after each visit as well as maintain notes from specialist referrals. The EMR could also be emailed to a referring physician prior to the initial appointment.

Each digital device is pre loaded with an abundance of self-help resources, toolkits, assessments and links that promote wellness and prevention designed to empower individuals to develop and sustain their sense of well-being and healthy lifestyle.

Another key feature to this claim, the creation of a proactive emergency preparedness program using digital technology that combines a crisis response transmittal services with a remote digital device called, My Crisis Capsule”. Special needs populations are most vulnerable in our society during a disaster or personal medical emergency episode and therefore this invention was created to fill the void existing in emergency preparedness planning.

The inventor focuses on the health and wellness seeking consumer and the use of these digital devices and transmittal services to best meet their needs and designed the PHR form like no other electronic PHR form. The design applied a person-centered and driven approach using a multi-dimensional model to maximize several benefits to all stakeholders, such as, the consumer, health care provider, first responders, payers employer groups, health plans health care facilities, emergency room personal, and caregivers . . . . Therefore, the content of the PHR form and the pre loaded content embedded in each device(s) have many far reaching benefits well beyond any PHR form or emergency preparedness digital device.

The actual PHR form uses a person-centered design that focuses on the person rather than “a case or a patient.” For example, the forms assessment domain focuses on the strengths and interest of the person as well as their medical profile of medical conditions. The form intends to offer first responders, for example, or medical emergency personal a sense of whom this person is as well as medical history, conditions and all relevant vital medical information, including their advance directives and crisis plan.

The scope and nature of this unique design goes well beyond other electronic PHR's and creates a new paradigm shift in the health care information technology industry. The prevailing provider-driven, patient centric approach is the current approach and design supported by national certification standards, such as those of the (CCHIT).

### The Market Analysis:

The inventor engaged in extensive market research before submitting this claim. The research results indicate there are firms that sell flash drives instructing the consumer to download their personal health record (PHR) information in a custom designed flash drive. The reason for the purchase is for a person is proactive and prepared to carry their personal health information on them in the event they are in an in medical emergency so that first responders will have immediate access to the person's health records to perform a knowledge-based assessments and intervention.

The rapid proliferation of information and communication technologies that have emerged during the last several years has both hopeful and alarming implications for the future. These technologies have already produced profound changes in the US economy and continue to exert increasing influence on many aspects of daily life, including personal health decisions and behaviors, health care delivery and financing, and public health systems.

The Electronic Medical Record (EMR) industry has recently emerged and is growing rapidly. The Obama Administration has plans to disperse 50 billion dollars towards the healthcare industry and has set as one priority the EMR. The EMR has been mandated by the Bush Administration requiring each physician office and hospital system have a functional EMR by 2014. The major seemingly unsolvable challenge is the creation of a global-interoperable EMR. Current private IT EMR vendors and provider systems are far from this desired outcome. In the interim, Theis and Associates, LLC has developed a Personal Health Record combined with a Crisis Response Transmittal Service that offers many features and multi-purposes, one being capability to transmit one's vital medical information during an emergency anywhere any time.

Evidence of this phenomenon is the growth of interactive heath communications (IHC): the interaction of an individual—consumer, patient, caregiver, or professional—with or through an electronic device or communication technology to access or transmit health information, or to receive or provide guidance and support on a health related issue. IHC applications include health information and support Web sites and other technology-mediated applications that relay information, enable informed decision making, promote healthy behaviors, promote information exchange and support, promote self-care, or manage demand for health services.

IHC applications have great potential to improve health and well-being. Compared to more traditional media, interactive media may have several advantages for health communication efforts. These include: improved access to individualized health information, broader choices for users; potential improved anonymity of users; greater access to health information and support on demand; greater ability to promote interaction and social support among users, and between consumers and health professionals; and enhanced ability to provide widespread dissemination and immediate updating of content or functions. Interactive health communication will play an essential role in enhancing health, minimizing total burden of illness, and optimizing relationships between individuals and health professionals.

There is little doubt that IHC applications will continue to grow in utility and popularity and consumers will increasingly turn to them for health information, communication, support, and health-related transactions. IHC has the potential to dramatically improve the ways in which people prevent disease, maintain their health, and recover from illness. IHC will play a pivotal and positive role in creating a healthier workforce, assuming a high percentage of employees (stakeholders) participate.

Theis and Associates, LLC has developed a Personal Health Record combined with a On Demand Crisis Response Transmittal Service that offers many features and multi-purposes, one being capability to transmit one's vital medical information during an emergency anywhere any time.

The special needs populations, baby boomer generation as caregivers of their aging parents and many other populations and scenarios are targeted for marketing. Institutions, such as universities, nursing homes, group homes, etc. are also the focus of prospecting efforts and sales. Emergency Preparedness Planners are considered to be in need of this product and transmittal service since they are mandated to implement “modern” emergency preparedness planning for the citizens in their communities. In addition, people are living longer, which means they may find a need for a device and program that aids them in times of personal crisis. The elderly often develop chronic illnesses and conditions making them vulnerable to injuries requiring emergency medical care.

### Competitive Analysis

There are some competition in the EMR industry, such as, GE Healthcare—iGate, eClinicWorks, and Quality Systems, Inc. brand name: NextGen. There are several life line products designed for first responder r but these firms offer no digital remote PHR transmittal service. Other firms sell to the consumer a pre-loaded PHR form that the consumer maintains on their own without a transmittal service or maintenance data base service. There is no known competition with the array of services and digital devices on the market at this time. Therefore, Theis and Associates, LLC is not competing directly with any large or small PHR company or does Theis and Associates have any plans to develop any agreements with other large health care companies.

The worldwide market for the EMR and PHR is expected to be significant

### Value Proposition

We want to reinvent the definition of pro activity in crisis responsiveness and intent to “raise the awareness” for the need for a higher standard of emergency responsiveness driven by the healthcare consumer empowered with their

In the interim, the Crisis Response Transmittal Service has the potential for improving beneficiary health outcomes. First responders will have up-to-date listing of medications, dosages and frequencies, names of prescribing physicians and pharmacies used in addition to information about the consumer's known side effects or other adverse reactions. Additionally, this innovation will improve quality and efficiency by actively promoting appropriate drug usage by providing information to first responders. The CRTS may play a significant role in efforts to reduce the incidence of drug diversion by alerting providers and pharmacists of duplicative prescriptions for controlled substances.

We now have given the consumer and or a primary caregiver, a sense of . . . security knowing their advance directives and vital medical information will be securely transmitted to first responders during a medical emergency anytime anywhere. This indeed is a “breakthrough in the digital age and this breakthrough will positively impact on the transformation movement to a consumer-driven healthcare system.

NOTE: An Institute of Medicine report estimates 1.5 million Americans are injured each year and 7,000 die from preventable medication errors. Yet, today, less than 4 percent of U.S. physicians have invested in an electronic medical record and less than 10% write prescriptions electronically.

Innovative products such as Web-based e-PHR card help put more patients at the center of their care.”

Employees will be able to send medical information that is documented in the e-PHR card before a clinical encounter to their referred physician for inclusion in their personal health record.

Web based e-PHR card is a key component to help improve the health and wellness of its own people. As one of the most innovative technology companies in the world, invest in secure, patient-centered and interoperable healthcare IT solutions

Computer-based interfaces also can increase a participant's willingness to engage in frank discussions about health status, behavioral risks and fears and uncertainties. Other Advantages include:
Increased access to information and support on demand because these resources often can be used at any time and from numerous locations.
Increased opportunity for users to interact with health professionals or to find support from others similarly situated through the use of networking technologies such as e-mail, which enables direct communication between individuals despite distance or structural barriers.
Enhanced ability for widespread dissemination and for keeping content current.
Informed decision making: Decision/support applications can foster communication among health care professionals and clients by helping clients understand prevention, diagnosis, or management of a health condition.
Promotion of healthful behaviors and sustaining healthful behaviors not only on an individual level but also on an employer-wide level. May include risk assessment and health promotion modules typically based on theories of behavioral change.
Peer information exchange and emotional support as increasing number of participants enable persons to discuss their specific health conditions, needs, or perspectives with others who have similar concerns. Through “virtual support communities,” for a wide array of medical conditions, participants may share information and provide peer and emotional support that typically cannot be obtained from health care professionals. This phenomenon may reflect peoples' tendency toward socialization and is one of the most common health-related uses of the Internet Participants in such support networks include consumers, patients, health professionals, and other caregivers.
Promotion of self-care: Helps users manage health problems without direct intervention from a health care professional and help supplement existing services. Some consumers using these resources may have limited access to a health care professional, have a particular interest in alternative medicine, or want information on therapies that may not be available from their health care provider.

### Value Statement

The most valuable component offered by RMWC is not the interoperable component, multi-dimensional functionality, the abundance of self-help wellness and preventative content loaded in a remote digital device, or the seamless referral to a certified wellness coach. The most valued component was the design itself-key component was the mindset that led to a consumer-focused, value-driven design its intellectual property. This unique approach was further refined as the PHR form embedded a person centered, strength-based design. Also, the consumer has the ability to interact with prompts generated from the PHR form that encourages real time evidence-based behavioral change theory that leads to action, such as a seamless and convenient referral to a wellness coach. The web-based server also has interactive features, such as; the consumer can create their own self-help library as they download content from the private server.

From the perspective of the provider, the electronically transmitted data sets are easily readable to first responders and displayed in a single view that includes the persons advance directives, vital medical information strengths, interest, perception of their health status, their readiness to change unhealthy lifestyles all designed to fully understand the person not just a method to gather personal health record information. We believe this approach will lead to desired outcomes.

We believe a well implemented, consumer-driven PHR will-have the potential to improve health care at an acceptable cost. To enable providers and payers to make serious commitments to implementing PHR there will need to be real-world demonstrations of how commercially available PHR can support improved care processes cost-effectively. Standards for interoperability and a Consumer Reports for PHR are both necessary and more needs to be known about cost-effective design, implementation, and technical support of PHR's.

This business plan strongly supports the notion that we need powerful financial consumer and provider incentives—such as a pay-for-performance—that will reward organizations for using PHRs to improve the quality and efficiency of U.S. health care. For consumers, incentives for those who seek out wellness initiatives that sustain healthy lifestyles through behavioral change would be a step in the right direction, a step facilitated by a progressive PHR system.

We seek to promote the importance of consumer empowerment, activation and meaningful input in the emerging electronic medical record (EMR) and personal health record (PHR) industry. This patent application seeks to change the traditional mindset of a patient metric health care IT approach to a person-centered value-driven approach towards the design of the (PHR). This approach, we believe has the as potential for becoming the “linchpin” for health care consumers to gain a foothold in a provider-driven system of Information Technology that dominates the healthcare system.

We hope our invention will begin a process of consumer advocacy since we envision the PHR will become main stream as the future of digital technology replaces paper in an accelerated pace throughout our global health care system. Indeed, it may be one of just a few consumer “toolkits” that offer a sense of control as they navigate through this daunting health care system.

We believe a consumer-focused, value-driven PHR design will enhance healthcare quality outcomes, reduce adverse occurrences and save a significant amount of consumer cost for health care. This invention may be the “silver bullet” we have been searching for in health care reform.

Within the world of health information technology the PHR is still viewed as an emerging product. To help transform the PHR into a consumer-driven model this white paper, seeks to change the mainstream traditional provider approach by demonstrating the inherent advantages and mutual benefits that can be achieved when both a consumer and provider driven-approach are applied in this emerging industry.

We live in a time, an era of great uncertainly as health care reform increases consumer anxiety and sense of helplessness. Many health care consumers sense a loss of control and feel somewhat disregarded within the provider-driven health care system and current health care reform proposed initiatives. The PHR unlike the Electronic Medical Record, as of yet, has no established sets of criteria or standards of definition for what features, functions or capabilities constitute a full-fledged PHR. With the wide range of approaches introduced by different PHR firms there have most recently been efforts for a consensus of certification standards and criteria.

The current definition is as follows:

The Personal Health Record (PHR) is an Internet-based set of tools that allows consumers to access and utilize their vital medical health information and make it readily available to those who need it.

The PHR is an integrated and comprehensive view of health information, including information consumers maintain, update and report themselves such as medical conditions, prescriptions, advance directives, diagnostic test results, and information from their pharmacies and insurance companies.

The use of PHR technology holds the key for enabling individuals to maintain a copy of their health information, share that information with family members however they wish, when and where and electronically transmit to health care providers.

Invention 1: Ability to Transform Itself while Sustaining a Consumer-Driven Model Multi-Purpose Design and Functions of the Invention

No Personal Health Record has been crafted using a person-centered approach combined with an On Demand Crisis Response Transmittal Service, an advance directive, a crisis plan, a self-help educational toolkit, a seamless referral to a certified wellness coach and offer multiple methods that serve to cue first responders by alerting and instruct first responders to access the CRTS during a personal medical emergency when a person is unconscious, unable to communicate or have “special needs.”.

First responders who are trained to seek to locate medical information at the scene of an emergency event. The inventor has created cues such as, a laminated tag attached to the digital devices key chain and a laminated Crisis Card to be placed inside a wallet or purse. The crisis capsule is designed with an engraved white cross and phone number of the CRTS. The color of the device is bright red and when a first responder inserts the device in their computer and or smart phone instructions to call the CRTS are provided along with information who the person is and their photo (photo is an optional feature).
The phone number is on the Crisis Card, tag, and digital device. Once the device is inserted in the URB port, the phone number and instructions appear on the computer screen. The first responders then call the CRTS and the 24/7 operating service verifies the identity of the first responder then immediately transmits the identified person's password protected PHR to the emergency triage email address.
This claim will reduce many adverse occurrences caused by the lack of information, poor collaboration and the “stigma” associated with special needs populations. These adverse events occur in emergency rooms where consumers are most vulnerable. The ER physician is unaware of the medical and social needs and performs an assessment and triage intervention without any knowledge of clear information from the disabled patient. The consumer consequently experiences, fear, helplessness and is vulnerable during these personal crisis events.
Having all of these unique features and services empowers individuals as they navigate through the complex health care system especially beneficial for those in a vulnerable medical emergency event.

Many have considered this a ‘breakthrough” that will have a profound impact on emergency crisis medical responsiveness and on consumer healthcare empowerment. Healthcare consumers will finally be empowered with their vital medical information and advance directives where as before, they had virtually no means to achieve empowerment during their most vulnerable and critical moments in their lives, a personal medical emergency.

Having all of these unique features and services empowers individuals as they navigate through the complex health care system especially beneficial for those in a vulnerable medical emergency event.

Individuals can update their information anytime on line then download their data into their digital device from the secure password protected data base

No Other Personal Health Record Management Firm or Emergency Transmittal Program Offers this Patent-Pended Multi-Purpose Design

### Content

The PHR digital devices include value-added wellness and preventive content. These digital devices are pre loaded with an abundance of self-help resources, toolkits, assessments and links that promote wellness and prevention designed to empower individuals to develop and sustain their sense of well-being and healthy lifestyle.

### Empowerment and Choice

Along with empowerment comes choice with a variety of devices for students and faculty to choose which style and features meet their personal needs. The e-PHR Card™ & My Wellness Capsule™ transform into an interoperable Electronic Medical Record (EMR). Empowered students and faculty, physicians and/or clinic staff use the device to exchange and update records after each visit as well as maintain notes from specialist referrals. The PHR could also be emailed to a referring physician prior to the initial appointment.

Laminated Crisis Card Included Along with Laminated Tag Attached to Key Chain

Especially when these persons are vulnerable and cannot communicate their medical and social needs during a personal medical crisis event. The Crisis Response Transmittal Service provides first responders with this interoperable feature found nowhere in other PHR. This fact represents a “breakthrough technology” in the healthcare industry as the first interoperable PHR that functions anywhere anytime on any computer so any first responder or hospital-based computer has immediate access to one's PHR during a disaster event or personal crisis event.

An interoperable PHR particularly for “special needs populations” we claim will reduce delays, omissions, medication errors, and loss of lives. Emergency room physician, first responders and disaster triage health professionals will have up-to-date vital medical information to perform a knowledge-based assessment and efficient triage intervention.

During a catastrophic event, first responders will have immediate access to the PHR and be aware of one's medical, psychiatric and social needs during chaotic triage situations. The inventor's crisis management experience in healthcare helped to conceptualize his Intellectual Property. The inventor realized there was no personal health record that was consumer-driven, meaning PHR's are driven by proprietary interest and provider-driven and not interoperable during “point of care,” more importantly during a medical emergency.

The device services as a cue to first responders who are trained to seek to locate medical information at the scene of an emergency event. The inventor has created additional cues included in this program, such as, a laminated tag attached to the digital devices key chain and a laminated Crisis Card to be placed inside a wallet or purse. Both clues instruct first responders to call the On Demand Crisis Response Transmittal Service (CRTS).

The phone number is on the Crisis Card, tag, and digital device. Once the device is inserted in the URB port, the phone number and instructions appear on the computer screen. The first responders then call the CRTS and the 24/7 operating service verifies the identity of the first responder then immediately transmits the identified person's password protected PHR to the emergency triage email address.

This invention will reduce many adverse occurrences caused by the lack of information, poor collaboration and the “stigma” associated with special needs populations. These adverse events occur in emergency rooms where consumers are most vulnerable. The ER physician is unaware of the medical and social needs and performs an assessment and triage intervention without any knowledge of clear information from the disabled patient. The consumer consequently experiences, fear, helplessness and is vulnerable during these personal crisis events.

### Invention 2: Interoperable and Portable Emergency Preparedness Device and GLOBAL On Demand Crisis Response Transmittal Service (CRTS)

### Portable and Interoperable

This award-winning optional feature was designed for use during a personal medical emergency. This patent pended program transmits vital medical information of a person's medical history, prescriptions, providers, advance directives, and more. For caregivers this is a convenient service and offers a “peace of mind” knowing medical records will be easily accessible in case of an emergency or if other medical measures are necessary. The transmittal is sent in an encrypted secure password protected file to a verified first responder. The program is interoperable and links to any first responder, emergency room computer or wireless phone ANYWHERE ANYTIME. Triage providers are empowered to perform a knowledge-based assessment and medical intervention. The outcome could save lives, reduce unnecessary diagnostic tests, health care costs; avoid medical errors, omissions, and delays. This CRTS™ is considered by many as a “breakthrough” being the first interoperable, consumer-driven electronic personal health record in the information technology industry. Unlike other personal health records, the web-based program transmits from a privately-held server with back up on a dedicated data base with no third-party affiliations or interest. This guarantees Safety* Security* Privacy
Vital information can include a person's advance directives to ensure first responders have an informed consent. This value-added and proactive feature empowers an individual even if they are unconscious or unable to communicate their wishes to first responders when critical decisions need to be made during a medical emergency.

A laminated crisis card Included along with laminated tag attached to the key chain on the device

This is an extraordinary feature, a digital personal health record, combined with a crisis response transmittal emergency preparedness service designed for special needs populations, baby boomer generation as caregivers of their aging parents and many other populations. Institutions, such as universities, nursing homes, group homes, etc. will benefit from this invention.

State Emergency Preparedness Planners are mandated to implement “modern” emergency preparedness planning for the citizens in their communities. People are living longer, which means more citizens need a digital device and on demand transmittal of their personal health record in times of personal crisis or a disaster event. The elderly often develop chronic illnesses and conditions making them vulnerable to injuries requiring emergency medical care.

This invention has the potential for improving beneficiary health outcomes. First responders will have up-to-date listing of medications, dosages and frequencies, names of prescribing physicians and pharmacies used in addition to information about the consumer's known side effects or other adverse reactions. Additionally, this innovation will improve quality and efficiency by actively promoting appropriate drug usage by providing information to first responders.

The invention may play a significant role in efforts to reduce the incidence of drug diversion by alerting providers and pharmacists of duplicative prescriptions for controlled substances. The consumer and a primary caregiver will have a sense of security knowing their advance directives and vital medical information will be securely transmitted to first responders during a medical emergency anytime anywhere.

### Key Prospects

As a personal health record, electronic medical record or emergency preparedness device for special needs populations, baby boomer generation as caregivers of their aging parents and many other populations and scenarios are targeted for marketing. Institutions, such as universities, nursing homes, group homes, etc. are also the focus of prospecting efforts and sales.

Emergency Preparedness Planners are considered to be in need of this product and transmittal service since they are mandated to implement “modern” emergency preparedness planning for the citizens in their communities. In addition, people are living longer, which means they may find a need for a device and program that aids them in times of personal crisis. The elderly often develop chronic illnesses and conditions making them vulnerable to injuries requiring emergency medical care.

University emergency preparedness program would benefit from these products and services for students and faculty with special needs. For off campus during travel these devices function anywhere anytime. No other emergency preparedness program can offer this sense of security knowing if one becomes sick or has a medical emergency the first responders will have access to their vital medical information and advance directives anywhere anytime.

### REFERENCE

Highlights from the American College Health Association campus violence white paper

Website:
ACHA's Healthy Campus 2010 establishes national health objectives and serves as a basis for developing plans to create college health programs and improve student health (ACHA, 2002).
According to the Violent Victimization of College Students report (Baum & Klaus, 2005), between 1995 and 2002, college students ages 18-24 were victims of approximately 479,000 crimes of violence annually
Attacks on Campus Faculty or Staff have received much publicity and is of great concern in the college health profession. Although statistics are not available on these attacks, this phenomenon is a serious threat to the health and safety of our faculty and staff. The Arizona State University nursing professor murders and the Case Western Reserve University shooting spree are examples of attacks that required the entire campuses to respond on multiple, coordinated levels to deal with the crimes and their aftermath.

The CRTS gives caregivers a sense of security knowing in the event of a crisis their loved one's PHR will be available to health care providers if one becomes sick or has a medical emergency anywhere anytime. Caregivers can also take advantage of the many care giving tips and resources preloaded in each device as a. standard feature

Consider how powerful this transmittal service can be during the most vulnerable episodes in the continuum of care, a personal medical emergency event. Supported by a secure, private web-based server independent of any third-party affiliates, or special interest groups, we perform a personalized service for consumers existing in a provider-driven IT environment.

Empowered physicians and/or clinic staff can use the device to exchange and update records after each visit as well as maintain notes from specialist referrals. The EMR/PHR could also be emailed to a referring physician prior to the initial appoint

According to a recent report from the Institute of Medicine (IOM), it is estimated that a savings of $156 million over five-years from the use of an electronic prescribing system program in avoided adverse drug events. It's been estimated that Medicare beneficiaries experience as many as 530,000 adverse drug events every year, contributed to in part by negative interactions with other drugs, or a prescriber's lack of information about a patient's medication history. According to the IOM, more than 1.5 million Americans are injured each year by drug errors. Electronic prescribing can help deliver safer, more efficient care to patients.

The On Demand Crisis Response Transmittal Service has the potential for improving beneficiary health outcomes. First responders will have up-to-date listing of medications, dosages and frequencies, names of prescribing physicians and pharmacies used in addition to information about the consumer's known side effects or other adverse reactions. Additionally, this innovation will improve quality and efficiency by actively promoting appropriate drug usage by providing information to first responders.

The CRTS may play a significant role in efforts to reduce the incidence of drug diversion by alerting providers and pharmacists of duplicative prescriptions for controlled substances. The consumer and or a primary caregiver has a sense of security knowing their advance directives and vital medical information will be securely transmitted to first responders during a medical emergency anytime anywhere. This indeed is a “breakthrough in the digital age and this breakthrough will positively impact on the transformation movement to a consumer-driven healthcare system.

### Note:

An Institute of Medicine report estimates 1.5 million Americans are injured each year and 7,000 die from preventable medication errors. Yet, today, less than 4 percent of U.S. physicians have invested in an electronic medical record and less than 10% write prescriptions electronically.

### Invention 3. Pre Loaded Value-Added Content:

The PHR digital devices include value-added wellness and preventive content. These digital devices are pre loaded with an abundance of self-help resources, toolkits, assessments and links that promote wellness and prevention designed to empower individuals to develop and sustain their sense of well-being and healthy lifestyle.

In addition to the preloaded PDF files, approximately 40 additional PDF files are available and accessible on line at the self-help library on the firm's private secure web site. The person can simply download their choice of topics directly from the web site to their digital device.

Each of these Digital Devices Transforms into a Self-Help Educational Toolkit with an Abundance of Content:

My Crisis Capsule™ Content
CRISIS RESPONSE TRANSMITTAL SERVICE
Welcome Letter
Fact Sheet
Confidentiality, Confidentiality Policy and Agreement of Release of Liability
Copyright Protection
Take An Active Role In Your Health
Brief Well-Being Assessment
Readiness to Change Questionnaire
Behavioral Change Exercise Template
Stress Management
Wellness Planning
   Examples of Personal Wellness Visions and Goals
   Example of Plans to Reduce Symptoms
   Example of Serious Symptoms (early warning signs)
   Example of Potential Triggers
   Example of Reminder Lists
   Examples of a Daily Maintenance Plans
Examples of Wellness Planning
Example of Wellness Plan
My Self-Help Wellness Toolkits and Resources
My Crisis Plan
Aging Myths and Caregiver Resources
Advanced Directives
CDC Immunization Guidelines
CDC Mental Health Report
Exercise Guidelines
Pathway to Wellness: A Healthy Recipe Book
Eldercare Consumer Guide
Medicare Prevention Benefits
National and Government Web Sites
Wellness, Disease and Prevention Web Sites and Links
Authorization for the Exchange of Vital Information to First Responders
Medical Release Forms
Release of Liability for CRTS membership
Wellness Toolkits and Assessments with Real-Time Results
Alcohol and Drug Self-Assessments Information and Resources
Local Community Resources
National/Government Web Sites
Disease Prevention and Wellness Links
Disaster Emergency Toolkit and Checklist
Wellness Strategies and Planning Guides
Stress Management Techniques
Personal Goal Setting
Problem-Solving Guide
Checklist for Common Problems and Resolutions
Using Medication Effectively
Caregiver Tips, Assessments and Resources
Crisis Plan template
My Maintenance Plans
My Reminder List
My Triggers
My Serious Symptoms (early warning signs)
My Plans to Reduce Symptoms
My Advance Directives and Crisis Plan

There are an abundance of preventative sites and their “learning tools” related links to healthy living, disease prevention, screenings and self-help resources such as:
Take an active role in your health-related to physician visit
Health and Wellness Medical Exam—what test, lab work to ask for
Readiness to change questionnaire
Examples of Wellness Planning
Facts about Stress with examples of techniques, guidelines and resources
Behavior Change Template
CDC Immunization Guidelines
Aging Myths and Caregivers Tips
Exercise Guidelines

Each digital device includes value-added wellness and preventive content. These digital devices are pre loaded with an abundance of self-help resources, toolkits, assessments and links that promote wellness and prevention designed to empower individuals to develop and sustain their sense of well-being and healthy lifestyle. In addition to the preloaded PDF files, approximately 40 additional PDF files are available and accessible on line at the self-help library on the firm's private secure web site. The person can simply download their choice of topics directly from the web site to their digital device.

### Invention 4: Special Needs Populations:

According to the 2000 US Census, approximately 20% of non-institutionalized individuals between ages 5 and 64 have some level of disability. For individuals over the age of 65, 42% have some degree of disability. As local communities develop their Pandemic influenza community disease control and prevention plans, these facts become significant factors when planning for the full range of impact on communities. Access to vital information is critical for the special needs population with:
Mental Disorders
Blindness and Visual Impairment
Auditory Disabilities (Deaf and Hard of Hearing)
Developmental Disabilities
Special Needs Older Adults

Identification of the needs for this population who require special assistance and/or exhibit challenging behaviors is essential during a pandemic response. In many cases, if authorities do not understand their symptoms, they will make decisions without any vital information. Local coordination is an important key to successful support for this population. It is most effective when vital information is readily at hand so that first responders can mobilize and rely on one's natural sources of support when attempting to access people with developmental disabilities. Since no data base exists My Crisis Capsule™ is the solution to access vital information.

Especially when these persons are vulnerable and cannot communicate their medical and social needs during a personal medical crisis event. The Crisis Response Transmittal Service provides first responders with this interoperable feature found nowhere in other PHR. This fact represents a “breakthrough technology” in the healthcare industry as the first interoperable PHR that functions anywhere anytime on any computer so any first responder or hospital-based computer has immediate access to one's PHR during a disaster event or personal crisis event.

This claim will reduce many adverse occurrences caused by the lack of information, poor collaboration and the “stigma” associated with special needs populations. These adverse events occur in emergency rooms where consumers are most vulnerable. The ER physician is unaware of the medical and social needs and performs an assessment and triage intervention without any knowledge of clear information from the disabled patient. The consumer consequently experiences, fear, helplessness and is vulnerable during these personal crisis events.

An interoperable PHR particularly for “special needs populations” we claim will reduce delays, omissions, medication errors, and loss of lives. Emergency room physician, first responders and disaster triage health professionals will have up-to-date vital medical information to perform a knowledge-based assessment and efficient triage intervention.

During a catastrophic event, first responders will have immediate access to the PHR and be aware of one's medical, psychiatric and social needs during chaotic triage situations. The inventor's crisis management experience in healthcare helped to conceptualize his Intellectual Property. The inventor realized there was no personal health record that was consumer-driven, meaning PHR's are driven by proprietary interest and provider-driven and not interoperable during “point of care,” more importantly during a medical emergency.

The device services as a cue to first responders who are trained to seek to locate medical information at the scene of an emergency event. The inventor has created additional cues included in this program, such as, a laminated tag attached to the digital devices key chain and a laminated Crisis Card to be placed inside a wallet or purse. Both clues instruct first responders to call the Crisis Response Transmittal Service (CRTS).
Password protected transmittal and secure encrypted data repository
Back up on titanium, crush resistant flash drive device
Flash drive device stored in fireproof container box

The phone number is on the Crisis Card, tag, and digital device. Once the device is inserted in the URB port, the phone number and instructions appear on the computer screen. The first responders then call the CRTS and the 24/7 operating service verifies the identity of the first responder then immediately transmits the identified person's password protected PHR to the emergency triage email address.

Most Web-based applications are not technically accessible to persons with disabilities using assistive technology not even factoring in sound usability design. Existing proprietary PHR products are not accessible for use by persons with disabilities.

PHR products should work properly and safely for all users, accessible electronic and information technology (AeIT) criteria (such as Section 508 of the Rehabilitation Act) are used to address these special needs populations. We offer a process to engage persons with disabilities as stakeholders in PHR usability and accessibility product through our customer service professional social Iwork and case management staff that are trained in servicing the special needs populations. No existing certification work group or proprietary PHR organization gas addressed this issue.

For individuals over the age of 65, 42% have some degree of disability. As local communities develop their Pandemic influenza community disease control and prevention plans, these capabilities become significant factors when planning for the full range of impact on communities.

Technical customer service assistance with data collection and data entry for this population who require special assistance and/or exhibit challenging behaviors is essential before, for example, a pandemic response. In many cases, if authorities are not aware of the special needs, symptoms, conditions and behaviors of this population they will make decisions without any vital information. Local coordination is an important key to successful support for this population. It is most effective when vital information is readily at hand so that first responders can mobilize and rely on one's natural sources of support when attempting to access people with developmental disabilities.

Since no private secure web-based data base exists My Crisis Capsule™ is a novelty business solution for the special needs population prior to a Disaster Event and serves as a proactive emergency planning toolkit for first responders to access vital information.

Especially when these persons are vulnerable and cannot communicate their medical and social needs during a personal medical crisis event. The On Demand Crisis Response Transmittal Service provides first responders with this interoperable feature found nowhere in other PHR. This fact represents a “breakthrough technology” in the healthcare industry as the first interoperable PHR that functions anywhere anytime on any computer so any first responder and/or hospital-based computers or smart phones has immediate access to one's PHR during a disaster event or personal crisis event.

An interoperable PHR particularly for “special needs populations” we claim will reduce delays, omissions, medication errors, and loss of lives. Emergency room physician, first responders and disaster triage health professionals will have up-to-date vital medical information to perform a knowledge-based assessment and efficient triage intervention.

During a catastrophic event, first responders will have immediate access to the PHR and be aware of one's medical, psychiatric and social needs during chaotic triage situations. The inventor's crisis management experience in healthcare helped to conceptualize his Intellectual Property. The inventor realized there was no personal health record that was consumer-driven, meaning PHR's are driven by proprietary interest and provider-driven and not interoperable during “point of care,” more importantly during a medical emergency.

The device services as a cue to first responders who are trained to seek to locate medical information at the scene of an emergency event. The inventor has created additional cues included in this program, such as, a laminated tag attached to the digital devices key chain and a laminated Crisis Card to be placed inside a wallet or purse. Both clues instruct first responders to call the On Demand Crisis Response Transmittal Service (CRTS).

The phone number is on the Crisis Card, tag, and digital device. Once the device is inserted in the URB port, the phone number and instructions appear on the computer screen. The first responders then call the CRTS and the 24/7 operating service verifies the identity of the first responder then immediately transmits the identified person's password protected PHR to the emergency triage email address.

This claim will reduce many adverse occurrences caused by the lack of information, poor collaboration and the “stigma” associated with special needs populations. These adverse events occur in emergency rooms where consumers are most vulnerable. The ER physician is unaware of the medical and social needs and performs an assessment and triage intervention without any knowledge of clear information from the disabled patient. The consumer consequently experiences, fear, helplessness and is vulnerable during these personal crisis events.

### Invention 5: Avoidance of Adverse Events Such as:

Triage Delays
Diagnostic Omissions
Medication errors
Loss of Life

According to a recent report from the Institute of Medicine (IOM), it is estimated that a savings of $156 million over five-years from the use of an electronic prescribing system program in avoided adverse drug events. It's been estimated that Medicare beneficiaries experience as many as 530,000 adverse drug events every year, contributed to in part by negative interactions with other drugs, or a prescriber's lack of information about a patient's medication history. More than 1.5 million Americans are injured each year by drug errors.

Medical errors are a major cause of injury and death in the United States. The now-famous 1999 report by the estimated that 44,000 to 98,000 people die in US hospitals each year as the result of medical errors. (This means that more people die from medical errors than from motor vehicle crashes, breast cancer or AIDS.)

The On Demand Crisis Response Transmittal Service has the potential to reduce adverse events in the emergency rooms. This claim will reduce many adverse occurrences caused by the lack of information, poor collaboration and the “stigma” associated with special needs populations. These adverse events occur in emergency rooms where consumers are most vulnerable. The ER physician is unaware of the medical and social needs and performs an assessment and triage intervention without any knowledge of clear information from the disabled patient. The consumer consequently experiences, fear, helplessness and is vulnerable during these personal crisis events. This claim is designed for both Disaster Emergency Preparedness Planning and/or a personal medical emergency event.

### Other Research:

The Governor's Task Force Report on Campus Safety, November, 2007; challenged every University campus to review their approach to emergency preparedness through assessment and review of current plans. Marquette University in consideration of this proposal can enhance their current wellness and emergency preparedness planning by implementing this progressive plan.

Highlights from the American College Health Association campus violence white paper

Website:
ACHA's Healthy Campus 2010 establishes national health objectives and serves as a basis for developing plans to create college health programs and improve student health (ACHA, 2002).
According to the Violent Victimization of College Students report (Baum & Klaus, 2005), between 1995 and 2002, college students ages 18-24 were victims of approximately 479,000 crimes of violence annually
Attacks on Campus Faculty or Staff have received much publicity and is of great concern in the college health profession. Although statistics are not available on these attacks, this phenomenon is a serious threat to the health and safety of our faculty and staff. The Arizona State University nursing professor murders and the Case Western Reserve University shooting spree are examples of attacks that required the entire campuses to respond on multiple, coordinated levels to deal with the crimes and their aftermath.
NOTE: An Institute of Medicine report estimates 1.5 million Americans are injured each year and 7,000 die from preventable medication errors. Yet, today, less than 4 percent of U.S. physicians have invested in an electronic medical record and less than 10% write prescriptions electronically.

### Invention 6: Benefits for Physicians

Physician practices will manage medical information more efficiently.

Examples include the following:
Save administrative time and cost of having to deal with paper and paper files
Simplified response method to inquiries about patient records
Migrate from paper to electronic PHR system with ease and without losing patient information in an efficient and concise electronic format.
Interoperable transmittal during a personal medical emergency anytime anywhere
Standardized capture or exchange with any system for routine office visits
Store electronic PHR regardless of system compatibility
Patient and Provider upload or download files with 1 G encryption flash drive
Access by Internet on a secure and private, non-commercial server directly to a remote computer or smart phone
Accessible while patient is on vacation or during emergencies
Access by authorized persons, such as caregivers, guardians and health professionals
Physician review of self-reported data prior to download in secure server
Patient has immediate access to self-help prevention and wellness content on their pre loaded digital device
Optional seamless referral to a certified wellness coaching’
PHR consolidated into one view
More satisfied patients
Immediate access of patient's vital medical conditions, current medications, allergies, etc. during a personal medical emergency

### Invention 7: Enhancement for Case Management-in-Home Visits and Caregivers:

Consumer empowerment is facilitated when case managers along with caregivers and consumers use self help educational information on prevention and wellness resources along with links and to local crisis resources during in-home visits. These pre loaded personal digital devices are very convenient to access during routine case manager's home visits or for when caregivers wish focus on any number of wellness issues, assessments and toolkits available “at their finger tips.”

### Example One

Case managers for the special needs populations can partner with their consumer during home health care visits and together work from the self-help wellness toolkits by inserting the device in the case managers lap top computer

Care managers can follow the easy instructions and co-create with their consumer, crisis plans, wellness plans, advance directives, etc. found in the abundance of information available in the device. From the sample forms in the device, case managers can efficiently obtain consent forms during home visits.

### Example Two

Disease Management nurse performs a nursing telehealth service to determine if a patient is predicted to experience soon a cardiac arrest. Upon determining this risk assessment contacts the CRTS and instructs the CRTS what hospital the patient will be admitted. The CRTS immediately transmits the password protected PHR to the identified hospital.

This invention will reduce delays, omissions, medication errors, and loss of lives. Emergency room physician, first responders and disaster triage health professionals will have up-to-date vital medical information to perform a knowledge-based assessment and efficient triage intervention.

### Unique Claim: Enhancement for Case Management-in-Home Visits:

### Scenario One:

Consumer-driven empowerment features include self-help prevention and wellness toolkits resources links and one's LOCAL crisis resources downloaded in their personal digital device, particularly beneficial for “special needs” populations

### Scenario One:

Case managers for the special needs populations can partner with their consumer during home health care visits and together work from the self-help wellness toolkits by inserting the device in the case managers lap top computer

Care managers can follow the easy instructions and co-create with their consumer, crisis plans, wellness plans, advance directives, etc. found in the abundance of information available in the device (see table of contents)

From the sample forms in the device, case managers can efficiently obtain consent forms during home visits.

### Scenario One:

Disease Management firms who perform nursing telehealth services, for example determine a patient is predicted to experience soon a cardiac arrest. Upon determining this assessment contacts the CRTS and instructs the CRTS what hospital the patient will be admitted. The CRTS immediately transmits the password protected PHR to the identified hospital.

### Invention 8: Cost Saving

These convenient, remote, functional, interoperable and secure multi-purpose features will achieve significant savings when unnecessary diagnostic test and consultations are avoided in emergency rooms. Consumer-driven health plans will continue to populate the healthcare landscape along with higher out-of-pocket co-pays, ER visit minimum coverage and higher deductibles. Many have considerer our devices and services as a “breakthrough for consumers” being the only interoperable consumer-driven model to emerge in the global IT healthcare market.

As the only interoperable PHR web-based program that functions anywhere anytime. CRTS will achieve significant-savings to our customer when unnecessary diagnostic test and consultations are avoided in the expensive emergency rooms.
Recently, the Center for Information Technology Leadership estimated that approximately $20 B could be saved each year in the US through the use of PHRs.
More than 70% of consumers support electronic healthcare data sharing.
Increasingly, companies that want to manage healthcare costs and increase employee satisfaction are looking at PHRs as a cornerstone of their health management strategy.
   Invention 9: PHR Form was Designed Using a Person-Centered, Strength-Based Assessment with Emphasis on the Person not as a Patient.

Includes:
Person—Centered Assessment and Summary
Description of Your Strengths and Interests:
Explanation of Your Illness(s) and My Risk Factors:
Description of Your Readiness to Change any Unhealthy Lifestyles You May Possess:
Description of Your Social Network and Family Involvement:
Identify Your Cultural, Spiritual and Environmental Supports:
Describe Your Level of Life Satisfaction and Overall Quality of Life:
Describe Your Life Goals:
Describe any significant crisis events or other relevant social service and/or health related interventions and/or any other information:

### Invention 10-Seamless Referral to a Certified Wellness Coach:

Unique Claim: A Seamless Referral to a Certified Wellness Coach
The Inventor's web-based 14 item well-being questionnaire completed online by the consumer immediately and seamlessly refers to a certified wellness coach who is matched based on the results obtained and reviewed in “real time” by the consumer. The prepared coach then contacts the consumer to schedule a sixty-minute wellness session followed by a written wellness plan submitted to the consumer.

### The Challenge: Executive Summary

The key attributes of this invention is that it is governed by the consumer and will follow them over their lifetime regardless of health plan, provider, care setting, facility, or geography. However, as with any nascent product market, there is little formal definition as yet for what features or capabilities constitute a full-fledged PHR. And, with the wide range of approaches introduced by different players in the industry, there has been little push so far for consensus.

The most valuable component offered by the RMWC e-PHR example, was not the interoperable component, multi-dimensional functionality, the abundance of self-help wellness and preventative content loaded in the remote digital device, or the seamless referral to a certified wellness coach. The most valued component was the design itself-key component was the mindset that led to a consumer-focused, value-driven design its intellectual property. This unique approach was further refined as the PHR form embedded a person centered, strength-based design. Also, the consumer has the ability to interact with prompts generated from the PHR form that encourages real time evidence-based behavioral change theory that leads to action, such as a seamless and convenient referral to a wellness coach. The web-based server also has interactive features, such as; the consumer can create their own self-help library as they download content from the private server.

Individuals managing their own medical care know first-hand how challenging it can be to keep track of important heath records. Whether one is managing a health condition or not, the need for multiple physicians, clinics and labs makes life-saving medical information difficult to find, yet alone manage. Imagine the complete medical records for your consumers in one organized, private secure record. A complete history of their own health care organized in an automated system for simple access as a data source for their personal health information—constantly-accurate and kept up to date.

Caregiver and/or care manager can update one's vital medical information with consent directly into the password protected web server at anytime. Such vital information may include: allergies to foods, new health conditions, over-the-counter or herbal medications or a recent referred doctor or an added emergency contact. Keeping track of a myriad of medical information is likely a constant source of stress and frustration. Most importantly, because someone's life is at stake, caregivers need to ensure that this medical information is always current and easily available in case of an emergency. By collecting vital medial information in one place gives caregivers a comprehensive and constantly up-to-date PHR of their loved one's medical history, conditions, current medications, etc. A simple online registration provides a membership status within minutes

From the perspective of the provider, the electronically transmitted data sets are easily readable to first responders and displayed in a single view that includes the persons advance directives, vital medical information strengths, interest, perception of their health status, their readiness to change unhealthy lifestyles all designed to fully understand the person not just a method to gather personal health record information. We believe this approach will lead to desired outcomes.

We believe a well implemented, consumer-driven PHR will-have the potential to improve health care at an acceptable cost. To enable providers and payers to make serious commitments to implementing PHR there will need to be real-world demonstrations of how commercially available PHR's can support improved care processes cost-effectively. Standards for interoperability and a Consumer Reports for PHR are both necessary and more needs to be known about cost-effective design, implementation, and technical support of PHR's.

Future PHR systems need to place great importance on the consumer needs without compromising functionality. Innovation has already introduced to the market an interoperable, remote PHR combined with an On Demand Crisis Response Transmittal Service. It is out hope other innovative programs will emerge enhanced digital technology.

Powerful financial consumer and provider incentives—such as a pay-for-performance—that will reward organizations for using PHRs to improve the quality and efficiency of U.S. health care. For consumers, incentives for those who seek out wellness initiatives that sustain healthy lifestyles through behavioral change would be a step in the right direction, a step facilitated by a progressive PHR system. The government is offering financial incentives for doctors and hospitals to add or upgrade their technology systems.

This is just the 21st century version of the paper healthcare record. Record keeping may have evolved, but you do not have to be in healthcare too long to realize that it is still a medieval cottage industry. There is a very high protective wall build by stakeholders who either have no incentive to share data nor do they have the capability. Key challenges include making the information systems “interoperable” and protecting patient privacy. Consumers already used to electronic banking and electronic buying, will be encouraged to ask their physicians why they continue to rely on bad handwriting to prescribe.

A private not public web-based PHR is defined as an extension of physicians' electronic health records. A stand-alone, non-commercial on line PHR is an Internet-based tool for consumers. We believe that the more access provided, the stronger the partnership that will be cultivated between consumers and clinicians, for example, the PHR on a remote digital device offers convenience, a way for physicians and consumers to co-create a shared personal health record and formulate a shared treatment plan.

To foster a collaborated PHR model we created an expanded role for the consumer and a consumer-focused business model was established to support this collaboration. Currently this business model for-a consumer-driven service delivery in our healthcare environment is weak.

Another challenge within the PHR is the lack of federal privacy protection for confidential health information stored by entities that are not covered by the Health Insurance Portability and Accountability Act. Whatever the business model for PHRs, lawmakers should require that the consumer user be clearly informed about the identity of the system's operator and the financial terms of any direct or indirect use of patient data. Stand-alone PHRs initially may be used more broadly because they will be able to serve as data intermediaries.

With the globalization of healthcare, it's time that individuals are able to share in the responsibility of managing the information created about them. We believe our patient-centered PHR approach and patent-pended transmittal service along with the other claims will offer consumers and organization many advantages as those sited above most notably, reduced health care cost and improve the overall quality of care.

Thus it is apparent that there has been provided in accordance with the invention that fully satisfies the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What we claim as our invention:

1. A method for distribution of medical information and patient services comprising:
providing coaches to effectuate behavioral changes in patients including addressing health, wellness, mental health, and productivity issues, wherein said coaches have undertaken coach training and use substantially the same coaching skills and methodology, and wherein the coaches are as a group heterogeneous in that some of said coaches possess credentials in nutrition and weight management, and some of said coaches possess credentials in mental health.

2. The method of claim 1, wherein said coaches have undertaken substantially the same health or wellness coach training.

3. The method of claim 1, wherein said coaches use a standardized evidence-based practice approach to manage the coaching process.

4. The method of claim 1, wherein at least some of the coaching conducted by the coaches by telephone.

5. The method of claim 1, wherein an employee is matched based on the specialty of the coach with whom he/she will work identified by the patient's results from their well being questionnaire.

6. The method of claim 1, wherein the digital devices make available to its consumers wellness information relevant to their wellness needs while promoting healthy lifestyles and consumer empowerment.

7. The method of claim 1, wherein disease management program, health promotion program, or wellness program can be integrated.

8. The method of claim 1, wherein the patient chooses to arrange for a seamless referral for telephone coaching sessions including
online registration and completion of well-being questionnaire,
triggering an automatic referral to a certified wellness coach who is matched based on the identified wellness needs from the persons scores;
immediately displaying these scores on the patient's desktop or wireless phone so they can see their results;
reviewing the same scores by the coach prior to the initiation of the initial call to schedule a telephone appointment.

9. The method of claim 8, wherein a sixty minute session allows for reviews and discussion of the scores and both coach and person proceed to arrive at a wellness vision, and both the patient and the coach co-create a wellness plan for working toward realizing the vision.

10. The method of claim 9, wherein the plan includes a set of larger three-month behavioral goals and a set of small weekly behavioral goals, the coach summarizes the wellness plan and delivers the wellness plan to the patient after the initial session, the patient further has two 45-minute coaching sessions, spaced 1-3 weeks apart and wherein these sessions are conducted telephonically, and at all times before, during and after the initiation of the coaching process, the person has immediate access to the downloaded wellness content within the digital device and recommended online resources, containing information relevant issue and toolkits to empower the person to achieve their wellness goals.

11. The method of claim 1, wherein the coaches are trained in one of at least three specialties selected from physical therapy, psychotherapy, life coaching, physical fitness, medical/disease management, nutrition, and weight management.

12. The method of claim 1, wherein the questionnaire is completed online by the consumer immediately and seamlessly refers to a certified wellness coach who is matched with the patient based on the results obtained and reviewed in real time by the consumer, and wherein the prepared coach then contacts the consumer to schedule a sixty-minute wellness session followed by a written wellness plan submitted to the consumer.

13. A method for providing behavioral health, wellness, mental health or productivity changes in a set of patients comprising: undertaking by coaches of coach training and using substantially the same coaching skills and methodology in treating the set of patients, and wherein the coaches are as a group heterogeneous in that some of said coaches, for example, possess credentials in nutrition and weight management, and some of said coaches possess credentials in mental health.

14. The method of claim 13, further comprising making available to patients a digital device that includes relevant wellness information to promote healthy lifestyles and consumer empowerment.

15. The method of claim 14, further comprising the integration of a disease management program, a health promotion program, or a wellness program.

16. The method of claim 13 further comprising the steps of:
a. increasing the utilization of health and wellness promotion;
b. decreasing the cost as a result of consumer empowerment;
c. providing a positive impact on existing wellness programs, such as health risks, and rising healthcare costs, and encourage integrated with disease management, health promotion, and wellness programs;
d. standardizing coaching sessions with a person, networking and providing collaboration among health care providers for consultation and cross-referrals;
e. matching a coach with a patient based on the identified wellness needs of the patient.

17. The method of claim 16, wherein a computerized nursing station is further provided with decompression means to process data.

18. The method of claim 17, wherein a unit is selected from the group comprising a cathode ray tube, and computer display panels.

19. The method of claim 13, wherein a communications interconnection system is provided with a cable switched voice means to interface between the patient and a public telephone network.

20. The method of claim 13, wherein the system further includes data storage means, search means, and retrieval means implemented through an interactive software means allowing a user to search the databases and retrieve data based on user defined search criteria.
